(19) United States
(12) Patent Application Publication
(10) Pub. No.: US 2026/0254768 A1
(43) Pub. Date: Aug. 27, 2026

(54) APPARATUS AND METHOD FOR REORDER BUFFER WITH SLIDING WINDOW IN A RECONFIGURABLE DATA PROCESSOR

(71) Applicant: SambaNova Systems, Inc., Palo Alto, CA (US)

(72) Inventors: Shashank VIJAYARANGA, Fremont, CA (US); David Brian JACKSON, Dana Point, CA (US); Raghu PRABHAKAR, San Jose, CA (US); Vinh Quang Nguyen, San Diego, CA (US); Faline FU, Palo Alto, CA (US)

(73) Assignee: SambaNova Systems, Inc., Palo Alto, CA (US)

(21) Appl. No.: 19/551,068

(22) Filed: Feb. 26, 2026

Related U.S. Application Data
(60) Provisional application No. 63/763,825, filed on Feb. 26, 2025.
(60) Provisional application No. 63/778,336, filed on Mar. 26, 2025.

(51) Int. Cl. H04L 47/50; H04L 12/18

(52) U.S. Cl. CPC H04L 47/50; H04L 12/18

(57) ABSTRACT

Techniques are disclosed for ordered delivery of packets from multiple source units to a destination unit in a reconfigurable data processor. A data processor may comprise an array of configurable units coupled by an interconnect network. The array of configurable units may include a plurality of source units and a destination unit. The plurality of source units may be configured to transmit packets to the destination unit, a first packet of the packets including a first sequence identifier and a second packet of the packets including a second sequence identifier. The destination unit may be configured to consume at least the first packet and the second packet in an order determined by the first sequence identifier and the second sequence identifier regardless of an order in which the first packet and the second packet are received from the plurality of source units.

### PRIORITY APPLICATION

This application claims the benefit of U.S. Provisional Patent Application No. 63/763,825, filed on Feb. 26, 2025, titled “Hardware Many-to-Many Sliding Window Reorder Buffer” (Atty. Docket No. SBNV1228USP 01) and U.S. Provisional Patent Application No. 63/778,336, filed on Mar. 26, 2025, titled “APPARATUS AND METHOD FOR REORDER BUFFER WITH SLIDING WINDOW IN A RECONFIGURABLE DATA PROCESSOR” (Atty. Docket No. SBNV1217USP01). Both provisional applications are hereby incorporated by reference for all purposes.

### CROSS-REFERENCE TO RELATED DOCUMENTS AND APPLICATIONS

This application is related to the following published documents which are hereby incorporated herein by reference:
Prabhakar et al., “Plasticine: A Reconfigurable Architecture for Parallel Patterns,” ISCA '17, June 24-28, 2017, Toronto, ON, Canada; and
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.
U.S. patent application Ser. No. 18/218,562, published as US 2024/0020261, entitled “Peer-To-Peer Route Through In A Reconfigurable Computing System,” filed on Jul. 5, 2023;
U.S. patent application Ser. No. 18/383,718, published as US 2024/0073129, entitled “Peer-To-Peer communication between Reconfigurable Dataflow Units,” filed Oct. 25, 2023;
U.S. patent application Ser. No. 16/239,252, now U.S. Pat. No. 10,698,853, entitled “Virtualization of a Reconfigurable Data Processor,” filed Jan. 3, 2019;
U.S. patent application Ser. No. 18/107,613, published as US 2023/0251839, entitled “Head Of Line Blocking Mitigation In A Reconfigurable Data Processor,” filed on Feb. 9, 2023, and
U.S. patent application Ser. No. 18/107,690, published as US 2023/0251993, entitled “Two-Level Arbitration in a Reconfigurable Processor,” filed on Feb. 9, 2023.

### BACKGROUND

### Technical Field

The present disclosure relates to data processors, and more particularly to packet ordering in reconfigurable data processors, such as reconfigurable data processors having arrays of configurable units coupled by interconnect networks.

### Background

In data processing systems, operations may depend on receiving data in a particular order. When multiple sources transmit data to a common destination over a network, maintaining the intended ordering of that data can be important to producing correct results.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a block diagram of an example system including a reconfigurable data processor coupled to a host processor and a memory, in accordance with example embodiments of the disclosure.

FIG. 2 illustrates a block diagram of an example computer architecture, in accordance with example embodiments of the disclosure.

FIG. 3 illustrates a block diagram of an example reconfigurable data processor including two arrays of configurable units and a top-level network, in accordance with example embodiments of the disclosure.

FIG. 4 illustrates a block diagram of an example array of configurable units including switches and address generation units, in accordance with example embodiments of the disclosure.

FIG. 5 illustrates a block diagram of an example array of configurable units including source units and a destination unit coupled by an interconnect network, in accordance with example embodiments of the disclosure.

FIG. 6 illustrates a block diagram of an example pattern memory unit including input buffers, control logic, and a memory store, in accordance with example embodiments of the disclosure.

FIG. 7 illustrates a diagram of an example many-to-one packet transmission configuration including a plurality of source units transmitting packets to a destination unit with a sliding transmission window, in accordance with example embodiments of the disclosure.

FIG. 8 illustrates a diagram of an example fine-grained interleaving configuration showing a credit cycle between a destination unit and a plurality of source units, in accordance with example embodiments of the disclosure.

FIG. 9 illustrates a diagram of an example transmission configuration showing source units withheld from transmitting when sequence identifiers are outside a transmission window, in accordance with example embodiments of the disclosure.

FIG. 10 illustrates a diagram of an example coarse-grained interleaving configuration in which an interleaving factor exceeds a reorder buffer size, in accordance with example embodiments of the disclosure.

FIG. 11 illustrates a diagram of an example coarse-grained interleaving configuration in which an interleaving factor is less than a reorder buffer size, in accordance with example embodiments of the disclosure.

FIG. 12 illustrates a block diagram of an example destination unit showing packets written into an input buffer at locations addressed by transmitted sequence identifiers, in accordance with example embodiments of the disclosure.

FIG. 13A illustrates a block diagram of an example destination unit and a plurality of source units showing the input buffer before consumption of packets, in accordance with example embodiments of the disclosure.

FIG. 13B illustrates a block diagram of the destination unit and the plurality of source units of FIG. 13A showing the input buffer after consumption of packets and transmission of a credit message, in accordance with example embodiments of the disclosure.

FIG. 14 illustrates a block diagram of an example source unit including a base offset counter, a per-packet offset, an adder, a comparator, a modulo unit, and a transmission window, in accordance with example embodiments of the disclosure.

FIG. 15 illustrates a flow diagram of an example method of transmitting packets from a source unit including computing an effective sequence value and comparing against a transmission window, in accordance with example embodiments of the disclosure.

FIG. 16 illustrates a flow diagram of an example method of receiving and consuming packets at a destination unit including transmitting a credit to a plurality of source units, in accordance with example embodiments of the disclosure.

### DETAILED DESCRIPTION

The following detailed description is directed to example implementations and is not intended to limit the scope of the claims. A person of ordinary skill in the art will recognize that many variations are possible without departing from the spirit and scope of the disclosed subject matter.

Example implementations of this disclosure describe methods, apparatuses, computer-readable media, and systems for ordered delivery of packets from multiple source units to a destination unit in a reconfigurable data processor.

Reconfigurable data processors such as coarse-grained reconfigurable arrays (CGRAs) may execute dataflow graphs by mapping operations onto configurable units interconnected by packet-switched networks. In such architectures, multiple source units may transmit packets to a common destination unit. Because the packets may traverse different paths through the interconnect network, the packets may arrive at the destination unit in a different order than the order in which they were generated. Out-of-order arrival may produce incorrect computation results at the destination unit if the destination unit consumes the packets in arrival order rather than in the intended sequence.

In some examples, one or more source units transmit packets containing transmitted sequence identifiers, and the destination unit stores the packets at input buffer locations addressed by the transmitted sequence identifiers, such that packets are placed in sequence identifier order regardless of the order in which they arrive. In some examples, the destination unit consumes packets from the input buffer in an order determined by the sequence identifiers and transmits a credit to one or more source units indicating a quantity of consumed packets, and the one or more source units maintain respective transmission windows that constrain which packets may be transmitted and advance the respective transmission windows in response to the credit.

In some examples, one or more source units maintain respective base offset counters that accumulate across successive iterations of a dataflow operation, and an effective sequence value is computed from a base offset counter and a per-packet offset assigned at compile time, enabling the same input buffer locations to be reused across iterations without a barrier synchronization. In some examples, the respective base offset counters have a higher bit-width than the transmitted sequence identifier, permitting the system to operate across a large number of iterations before a counter is reset. In some examples, the credit is transmitted as a multicast message on a scalar interconnect network, such that a single credit message causes the one or more source units communicating with a given destination unit to advance their respective transmission windows by the same quantity.

In many implementations, the disclosed technology may improve packet-ordering workflows in reconfigurable data processors by enabling a destination processing unit to receive packets from multiple source processing units over an interconnect network and to consume those packets in a correct sequence-identifier order, even when packets arrive out of order due to variable-latency routing paths through the network. Rather than dedicated reorder hardware at each destination or communication restricted to deterministic single-path routing, the disclosed technology may repurpose an existing input buffer at the destination as a sequence-identifier-addressed reorder buffer, coordinate transmission timing across all contributing sources through a sliding transmission window, and sustain multi-iteration operation through accumulated offset counters, thereby collectively enabling correct, efficient, many-to-one ordered delivery in a reconfigurable array architecture.

For a given many-to-one communication pattern, each source processing unit may compute a sequence identifier for its packet and store the packet in the destination's input buffer at a location addressed by that sequence identifier. Because the transmission window may constrain all sources to a common range of valid sequence identifiers, and because the destination may consume packets in sequence-identifier order and broadcast a single credit signal to all sources upon consuming a defined quantity of consecutive packets, the per-packet workflow at the destination may reduce to an indexed write followed by an in-order read, with no sorting of arriving packets, no separate per-source queues, and no comparison-based merge operations.

This direct-addressed reorder mechanism may yield concrete time and compute savings. Many real-world dataflow graphs mapped onto reconfigurable processor arrays involve multiple processing units producing results that may be consumed in a defined order by a single downstream unit. When the interconnect network routes packets along different paths, those packets may arrive at the destination in an order different from the order in which they were generated. Conventional approaches may either add dedicated reorder-buffer hardware at each destination (consuming silicon area, adding pipeline stages, and increasing design complexity) or restrict the network to deterministic routing that avoids reordering at the cost of reduced bandwidth utilization and increased worst-case latency. By contrast, the disclosed technology may convert an input buffer that would otherwise function as a simple first-in-first-out queue into a reorder buffer by addressing it with the sequence identifier rather than with an arrival-order pointer. This may eliminate the need for dedicated reorder hardware at each destination, reduce the silicon area and power consumed by ordering logic, and enable the interconnect network to exploit multiple routing paths for improved throughput and fault tolerance.

The disclosed technology may also improve the precision and granularity of flow control by operating at the level of individual packet sequence identifiers, rather than treating source-to-destination communication channels as indivisible flows. During transmission, each source processing unit may evaluate whether its packet's sequence identifier falls within the current transmission window before transmitting, and may withhold transmission when the identifier is outside the window. This per-packet, per-identifier gating may prevent buffer overflow at the destination while allowing all sources to transmit concurrently whenever their respective packets fall within the valid range.

Because the flow-control mechanism may be grounded in a shared transmission window that all source processing units maintain coherently, the system may distinguish between packets that the destination is prepared to receive (identifiers within the window) and packets that would overwrite unconsumed data if transmitted prematurely (identifiers outside the window). In some implementations, the system may further classify source readiness into categories such as “within window and ready to transmit,” “within window but awaiting network resources,” or “outside window and gated,” based on the relationship between each source's next sequence identifier and the current window bounds, providing finer scheduling granularity than prior binary backpressure schemes that may simply assert or deassert a single flow-control signal per channel.

Modern reconfigurable data processors, including but not limited to coarse-grained reconfigurable architectures, may comprise arrays of configurable processing units interconnected by packet-switched networks. Dataflow graphs mapped onto these arrays may involve a destination processing unit receiving packets from a plurality of source processing units and consuming those packets in a defined sequence, even though the interconnect network may deliver them out of order due to differences in routing path length, congestion, arbitration delay, or interleaving of packets from different sources.

In one approach, dedicated reorder-buffer hardware may be instantiated at each destination that uses ordered delivery. These hardware reorder buffers may use content-addressable memory or comparison logic to accept packets in any arrival order and re-sequence them before delivery to the destination's processing pipeline. Such dedicated-hardware approaches may consume substantial silicon area, increase power dissipation, and add pipeline latency at every destination. In architectures where any configurable unit may serve as a destination for ordered traffic, provisioning dedicated reorder hardware at every unit may be impractical, and provisioning it only at selected units may constrain the dataflow graphs that can be mapped onto the array.

In another approach, the interconnect network may be restricted to deterministic routing (e.g., dimension-ordered or single-path routing), such that all packets between a given source-destination pair traverse the same path and arrive in transmission order. Deterministic routing may eliminate the reordering problem but may underutilize network bandwidth, increase susceptibility to localized congestion, and prevent the network from exploiting alternative paths when a primary path is blocked. Both approaches may suffer from scalability limitations: dedicated reorder hardware may not scale efficiently as the number of configurable units in the array increases, and deterministic routing may not sustain the bandwidth demands of large dataflow graphs with many concurrent communication flows.

Furthermore, many existing flow-control mechanisms may not be sensitive at the level of individual packet sequence within a many-to-one communication group. Conventional credit-based flow-control schemes may track available buffer space on a per-link or per-channel basis, issuing credits when buffer entries are freed. When multiple independent sources contribute to a single ordered stream at a common destination, per-link credit schemes may permit a source to transmit a packet that, while fitting within the destination's total buffer capacity, would arrive with a sequence identifier for which the buffer position is still occupied by an unconsumed packet from a previous window cycle. Such aliasing may corrupt the reorder buffer and produce incorrect consumption order.

The presence of multi-iteration dataflow operation may exacerbate these problems, because in iterative execution a destination may need to receive and correctly order packets across successive iterations of the same dataflow graph. If the sequence-identifier space is narrow (e.g., when the identifier is carried in a packet-header field of limited bit width), the identifier values may wrap around across iterations, causing a packet from a later iteration to be written to the same buffer location as an unconsumed packet from an earlier iteration. As a result, many conventional systems may either restrict the sequence-identifier space to be large enough to avoid wraparound (consuming header bits and buffer entries) or, conversely, may use a full synchronization barrier between iterations to drain the reorder buffer before new packets can be accepted.

In short, there may be a need for a computer-implemented packet-ordering technique that may, among other things, enable correct reordering at a destination without dedicated reorder hardware, coordinate transmission from multiple independent sources through a shared flow-control mechanism that may prevent buffer aliasing, support multi-iteration operation with a narrow transmitted sequence-identifier field, and be invoked efficiently at run time using per-packet computations that may be constant with respect to the number of sources or iterations.

The disclosed technology may address these problems by converting a destination's input buffer into a sequence-identifier-addressed reorder buffer, gating source transmissions through a coherent sliding transmission window, and sustaining multi-iteration operation through accumulated base offset counters that extend the effective ordering space beyond the width of the transmitted sequence-identifier field.

In one aspect, a data processor may comprise an array of configurable units coupled by an interconnect network. A destination unit of the array may comprise an input buffer having a plurality of entries. When the destination unit receives a packet from one of a plurality of source units, the input buffer may store the received packet at a location in the buffer addressed by the sequence identifier included in the packet, rather than at the next available location in arrival order. The destination unit may then read packets from the input buffer in order of the sequence identifiers, regardless of the order in which those packets arrived over the network. In some implementations, the input buffer may comprise a circular buffer, and the mapping from sequence identifier to buffer location may comprise a modular reduction of the sequence identifier by the number of entries in the buffer. In other implementations, the buffer may comprise a direct-mapped structure in which the sequence identifier or a portion thereof serves directly as a write address. Hybrid approaches are also possible; for example, a multi-bank buffer in which one field of the sequence identifier selects a bank and another field selects an entry within the bank.

In some implementations, the destination unit may maintain a valid indicator per buffer entry (e.g., a valid bit) indicating whether a packet has been received and stored at that location. The destination unit may determine that a quantity of packets corresponding to consecutive buffer locations starting at a consumption position indicator have been received by checking that the valid indicators for those consecutive locations are all set. In other implementations, the destination unit may determine readiness through alternative mechanisms, such as a count of consecutively received entries or an occupancy bitmap. Upon consuming a packet from a buffer entry, the destination unit may clear the valid indicator for that entry, making the entry available for reuse in a subsequent window cycle.

In another aspect, each source unit of the plurality of source units may maintain a transmission window defining a range of sequence identifiers. A source unit may be configured to transmit a packet to the destination unit when the sequence identifier of the packet is within the transmission window, and to withhold transmission when the sequence identifier is outside the window. In some implementations, the transmission window at each source unit may be coherent across the plurality of source units, such that each source unit maintains a same range of valid sequence identifiers at any given time.

The destination unit may be configured to, upon consuming a predetermined quantity of packets in sequence-identifier order beginning at the consumption position indicator, transmit a credit signal to each of the plurality of source units. In some implementations, this credit signal may comprise a single broadcast message transmitted simultaneously to all sources over a control network. In other implementations, the destination unit may transmit individual credit messages to each source unit. The credit signal may encode the predetermined quantity of packets consumed, or the sources may be preconfigured with the consumption quantum. In response to receiving the credit, each source unit may advance the transmission window (e.g., by incrementing a lower bound and an upper bound of the range by the consumed quantity).

In some implementations, a difference between the upper bound and the lower bound of the transmission window may equal the number of entries in the destination's buffer, such that the set of sequence identifiers currently valid for transmission may correspond to the set of buffer locations available for writing. In other implementations, the window may be smaller than the buffer to provide a guard band, or larger if the buffer supports overwrite-tolerant storage. The window size may be configurable.

In some implementations, each source unit in the many-to-one group may include an offset counter per destination. In other implementations, a subset of the source units in the group may include offset counters, while the remaining source units may transmit packets using statically assigned sequence identifiers that may not depend on an accumulated offset. The offset counter may be configured to accumulate an aggregate number of packets generated across the plurality of source units per iteration of a configured data processing operation. At the end of each iteration, each source unit may increment its offset counter by a value based on the total number of packets transmitted by all source units in the group to the destination during that iteration. A sequence identifier for a packet produced by a source unit may be determined by adding a per-packet ordering component, which may be configured at configuration time and may remain unchanged across successive iterations, to the current value of the offset counter. The result of this addition may constitute an effective ordering value.

In some implementations, the effective ordering value, the offset counter, and the bounds of the transmission window may each have a bit width greater than the bit width of the transmitted sequence identifier carried in the packet header. The source unit may derive the transmitted sequence identifier by mapping the effective ordering value to one of the plurality of entries in the destination's buffer (e.g., by computing a modular reduction of the effective ordering value by the buffer size). Window comparison and advancement may occur in the wider space of the effective ordering value, while only the narrow transmitted identifier may be placed on the network. This two-space architecture may enable the system to reuse the same set of buffer locations across iterations without aliasing, because the wider effective ordering values for different iterations may be distinct even when their modular reductions to transmitted identifiers are identical.

In some implementations, the system may perform a synchronization event to reset the offset counter and the transmission window when the effective ordering value approaches a wraparound boundary of its wider representation. In other implementations, the wider bit width may be chosen to be large enough that wraparound does not occur within the expected operational lifetime of a single configuration. The number of iterations supportable between synchronization events may scale with 2 raised to the power of the difference between the wide bit width and the narrow bit width.

The techniques may be implemented in a data processor comprising an array of configurable units coupled by an interconnect network, the array including a plurality of source units and a destination unit. In some implementations, the data processor may comprise a reconfigurable data processor (e.g., a coarse-grained reconfigurable architecture) coupled to a host processor, with the host processor providing configuration data that configures the plurality of source units and the destination unit for a particular dataflow operation. A memory may be coupled to the reconfigurable data processor.

In some implementations, the interconnect network may comprise a first network coupling the plurality of source units to the destination unit for transmitting packets and a second network distinct from the first network for transmitting the credit signal. The separation of data and credit paths may prevent credit signals from being delayed by data-packet congestion.

In some implementations, the sequence identifier may comprise a source-identifying portion identifying which source unit transmitted the packet and a position-identifying portion indicating a position within a sequence of packets from that source unit. The respective bit widths of the source-identifying portion and the position-identifying portion may be configurable.

The techniques may also be embodied in a non-transitory computer-readable medium storing configuration data that, when loaded into a reconfigurable data processor, configures the processor to perform the methods described herein.

The disclosed technology may provide concrete technical improvements to computer-implemented packet-ordering and flow-control mechanisms in reconfigurable data processors, rather than merely reorganizing abstract scheduling or sequencing information.

Because packet reordering may be performed by addressing the destination's input buffer with the sequence identifier, the system may achieve correct in-order delivery without dedicated reorder hardware at each destination. This may reduce silicon area, power consumption, and design complexity compared to approaches that provision separate reorder-buffer circuits. The input buffer, which may already be present at each configurable unit for receiving incoming packets, may serve a dual purpose, both receiving and reordering, with no additional buffer memory used. This dual use may represent a tangible reduction in the hardware resources consumed by the ordering function.

By coordinating all source units through a coherent sliding transmission window and a broadcast credit mechanism, the system may prevent buffer aliasing (e.g., the condition in which a newly transmitted packet overwrites an unconsumed packet occupying the same buffer location) without per-source flow-control channels at the destination. A single credit signal broadcast to all sources may replace what would otherwise be a set of individual credit returns, reducing the control-traffic bandwidth on the interconnect network and simplifying the destination's credit-management logic. The per-packet gating at each source (e.g., transmitting only when the packet's sequence identifier falls within the window) may impose a lightweight, constant-time check that may not scale with the number of sources or the depth of the buffer.

The use of accumulated base offset counters with per-packet ordering components that remain static across iterations may enable the system to amortize the cost of sequence-identifier configuration across arbitrarily many iterations. Because the per-packet ordering components may be set once at configuration time and remain unchanged, and because the base offset counter may be incremented by a single aggregate value at each iteration boundary, the per-iteration overhead may be constant regardless of how many packets each source produces. This may produce a tangible performance improvement at the systems level, particularly in iterative dataflow computations where the same communication pattern repeats across many iterations.

The two-space architecture, in which wider effective ordering values may be used for window comparison and counter accumulation while narrower transmitted identifiers are placed on the network, may further improve efficiency by enabling the packet-header sequence-identifier field to remain narrow (conserving header bits and buffer-address width) while still supporting extended operation across many iterations without aliasing. The number of iterations supportable between synchronization events may grow exponentially with each additional bit of width in the wider space, enabling the system to operate for long periods without the latency penalty of a full synchronization barrier.

Handling of iteration boundaries through accumulated offset counters rather than full-drain synchronization barriers may further reduce pipeline stalls that might otherwise involve the destination consuming all outstanding packets before new-iteration packets can be accepted. In some implementations, packets from a new iteration may begin arriving at the destination while the destination is still consuming the final packets of the previous iteration, provided the effective ordering values do not conflict which may be a property given by the wider internal space.

Collectively, these features may improve how reconfigurable data processors execute many-to-one ordered communication by enabling correct packet reordering using fewer hardware resources, tighter flow control using fewer control signals, and sustained multi-iteration operation using narrower packet-header fields than may be practical with dedicated-reorder-hardware approaches or single-path-routing approaches.

The following examples illustrate various implementations and use cases enabled by the present disclosure. These examples are provided for illustration and are not intended to limit the scope of the claims. In various implementations, the methods and systems described herein may be applied to different processor architectures, batch sizes, model configurations, and application contexts.

In an example, in a deep learning training workload, a matrix multiplication operation may be distributed across multiple pattern compute units (PCUs) in an array of configurable units. Each PCU may compute a partial sum of a row-column product and may transmit the partial sum to a destination pattern memory unit (PMU) for accumulation. In an array configuration for a large matrix multiply, four source PCUs 702a-702d may each produce partial sums that may be accumulated at destination PMU 704 in a defined sequence to help ensure bitwise-reproducible training results.

Without ordered delivery, the partial sums may arrive at destination PMU 704 in different orders across different executions of the same dataflow graph, depending on network congestion and routing path variation in the array-level network. Because floating-point addition may not be associative in general, accumulating partial sums in different orders may produce different numerical results, which may make training non-reproducible.

In this implementation, a compiler may assign each source PCU 702a-702d a per-packet sequence identifier offset (e.g., source PCU 702 a may be assigned offset 0, source PCU 702 b may be assigned offset 1, source PCU 702c may be assigned offset 2, and source PCU 702d may be assigned offset 3). Each source PCU may compute an effective sequence value from its assigned offset and a base offset counter, and may transmit a packet containing the partial sum and a transmitted sequence identifier derived by modulo reduction of the effective sequence value. Destination PMU 704 may store each arriving partial sum at the input buffer location addressed by the transmitted sequence identifier, may set the corresponding valid bit, and may accumulate the partial sums in sequence identifier order once consecutive valid entries are available. Because the accumulation order may be determined by the sequence identifiers rather than by arrival order, the training result may be bitwise reproducible regardless of network path variation.

The matrix multiplication may be executed iteratively across batches of training data. The base offset counter at each source PCU may be incremented by the aggregate number of partial sums produced across all source PCUs at the end of each iteration, enabling the same input buffer locations to be reused across iterations without a barrier synchronization. For a training run involving thousands of iterations, the higher bit-width of the base offset counter relative to the transmitted sequence identifier may permit continuous operation without counter reset.

In another example, in an inference workload that performs embedding table lookups, a host processor may issue a batch of sparse memory read requests through multiple memory interface units. Each memory interface unit may access a different region of off-chip memory and may return lookup results to a destination PMU that assembles the results into a dense output vector. Because off-chip memory latency may vary depending on DRAM bank conflicts, refresh cycles, and queuing depth at each memory interface, the lookup results may arrive at the destination PMU in an order that differs from the request order.

In this implementation, each memory interface unit may act as a source unit 702 that tags each returning lookup result with a transmitted sequence identifier corresponding to the position of that result in the output vector. The destination PMU 704 may write each arriving result to the input buffer location addressed by the transmitted sequence identifier. The destination PMU may read results from the input buffer in sequence identifier order and may transmit a credit to all source memory interface units when a batch of consecutive results has been consumed. The credit may cause each source memory interface unit to advance its transmission window, permitting the next batch of requests to be issued.

The transmission window may prevent any source memory interface unit from issuing requests that would overwrite unconsumed results in the destination PMU's input buffer, even when one memory interface unit returns results significantly faster than another due to favorable DRAM conditions. The sliding window size may be set equal to the input buffer depth at the destination PMU, and the compiler may configure the per-packet offsets at compile time based on the number of source memory interface units and the expected batch size.

In another example, in a transformer model executing multi-head attention, each attention head may be mapped to a separate group of configurable units in the array. Each group may compute attention scores and weighted values for its respective head and may transmit the per-head output to a destination PMU that concatenates the outputs from all heads into a single vector for subsequent projection.

In a configuration with eight attention heads, eight source unit groups 702a-702h may each produce a per-head output vector. The compiler may assign non-overlapping per-packet sequence identifier offsets to each source group corresponding to the concatenation position of that head's output in the final assembled vector. Source group 702a (head 0) may be assigned offsets covering positions 0 through N-1 of the output vector, source group 702b (head 1) may be assigned offsets covering positions N through 2N-1, and so on.

Each source group may compute effective sequence values and may transmit packets with modulo-reduced transmitted sequence identifiers. The destination PMU 704 may store each arriving per-head output at the input buffer location addressed by the transmitted sequence identifier, assembling the concatenated multi-head output in place regardless of which head completes computation first. The destination PMU may read the assembled vector in sequence identifier order and may broadcast a credit to all source groups when a batch of consecutive entries has been consumed.

This implementation may be executed repeatedly across tokens in an input sequence. The base offset counter at each source group may advance at the end of each token's attention computation, and the same input buffer locations may be reused for the next token without synchronization between the source groups and the destination PMU beyond the credit mechanism.

In another example, in a scientific computing workload that performs iterative stencil updates on a two-dimensional grid, the grid may be partitioned into tiles, and each tile may be mapped to a configurable unit in the array. At each iteration, each configurable unit may compute updated values for its tile and may transmit boundary rows and columns to neighboring tiles. A destination configurable unit that uses boundary data from multiple neighbors (e.g., north, south, east, and west neighbors in a five-point stencil) may receive the boundary data in a defined order to correctly index into its local scratchpad memory.

In this implementation, four neighboring source units 702a-702d may each transmit boundary data to destination unit 704. The compiler may assign per-packet sequence identifier offsets such that north boundary data occupies positions 0 through M-1, south boundary data occupies positions M through 2M-1, east boundary data occupies positions 2M through 3M-1, and west boundary data occupies positions 3M through 4M-1, where M is the number of boundary elements per edge. The destination unit 704 may store arriving boundary packets at input buffer locations addressed by the transmitted sequence identifiers and may read the boundary data in order for use in the stencil update computation.

The stencil computation may repeat for a large number of iterations (e.g., thousands of time steps in a fluid dynamics simulation). The base offset counter at each source unit may be incremented by 4M (the total number of boundary packets across all four neighbors) at the end of each iteration. Because the base offset counter may operate in a numerical space with higher bit-width than the transmitted sequence identifier, the system may execute thousands of stencil iterations without a barrier synchronization to reset sequence identifier counters. For a configuration with M=32 boundary elements per edge and a 16-bit base offset counter, the system may operate for over 500 iterations before the counter approaches its maximum value, at which point a barrier synchronization may reset the counters and transmission windows for continued operation.

The foregoing examples illustrate several ways in which sequence-identifier-addressed buffering, sliding window flow control, and base offset counter accumulation may be combined to achieve ordered packet delivery from multiple source units to a destination unit in a reconfigurable data processor. These examples may be mixed and matched; for example, the same deployment may use sequence-identifier-addressed write for partial sum accumulation in a training workload, sliding window credit-based flow control for scatter-gather memory access patterns, and base offset counter accumulation for iterative stencil computations with boundary exchange. Together, they may support and enable the full scope of the method, apparatus, and system claims, while also providing concrete technical effects useful to improve the functionality of a computer system. These effects may include, but are not limited to: (i) in-order consumption of packets at a destination unit despite out-of-order arrival caused by non-deterministic network routing, (ii) bitwise-reproducible computation results across executions of the same dataflow graph by eliminating dependence on arrival order, (iii) elimination of barrier synchronization overhead between iterations by reusing input buffer locations across successive iterations through base offset counter advancement, (iv) reduced scalar network bandwidth consumption by transmitting a single multicast credit message to all source units rather than per-source credit messages, (v) prevention of input buffer overflow through transmission window enforcement at each source unit without centralized coordination, and (vi) increased effective utilization of input buffer capacity by enabling the same buffer slots to be written, consumed, and reused within a single iteration as credits flow. These improvements may enable the disclosed systems and methods to achieve higher throughput and lower synchronization overhead compared to barrier-based or FIFO-based packet ordering approaches.

It should be understood that any description herein of a method performing an action or function, a system performing an action or function, or an apparatus performing an action or function is not intended to limit the disclosure to any particular statutory class. Descriptions of methods, systems, apparatuses, and computer-readable media are interchangeable, and any feature described in connection with one statutory class provides support for the others. For example, a method step described herein also describes a system or apparatus configured to perform that step, and a computer-readable medium storing instructions that, when executed, cause a processor to perform that step. Similarly, a system or apparatus described as configured to perform an action or function also describes a method comprising that action or function and a computer-readable medium storing instructions to perform that action or function.

### Terminology

As used herein, the phrase “one of” should be interpreted to mean exactly any one of the listed items. For example, the phrase “one of A, B, and C” should be interpreted to mean any of: only A, only B, or only C

As used herein, the phrases “at least one of” and “one or more of” should be interpreted to mean one or more items. For example, the phrase “at least one of A, B, or C” or the phrase “one or more of A, B, or C” should be interpreted to mean any number of the items of A, B, and/or C. The phrase “at least one of A, B, and C” means at least one of A and at least one of B and at least one of C.

Unless otherwise specified, the use of ordinal adjectives “first”, “second”, “third”, etc., to describe an object, merely refers to different instances or classes of the object and does not imply any ranking or sequence. The terms first, second, third and the like in the claims or/and in the Detailed Description, as used in a portion of a name of an element, are used for distinguishing between similar elements and not necessarily for describing a sequence, either temporally, spatially, in ranking or in any other manner. It is to be understood that the terms so used are interchangeable under appropriate circumstances and that the implementations or embodiments described herein are capable of operation in other sequences than described or illustrated herein.

The terms “comprising” and “consisting of” have different meanings in this document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be indirect through galvanic, capacitive, inductive, electromagnetic, optical, or through any other electrical element or process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item or circuit elements can be configured to perform the task even when the unit/circuit/component is not currently on or active. In general, the circuitry that forms the structure corresponding to “configured to” may include hardware circuits, and may further be controlled by switches, logical or analog electronics, fuses, bond wires, metal masks, firmware, and/or software. Similarly, various items may be described as performing a task or tasks, for convenience in the description. Such descriptions should be interpreted as including the phrase configured to. Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The words “during”, “while”, and “when” as used herein relating to circuit operation are not exact terms that mean an action takes place instantly upon an initiating action but that there may be some small but reasonable delay(s), such as various propagation delays, between the reaction that is initiated by the initial action. Additionally, the term “while” means that a certain action occurs at least within some portion of a duration of the initiating action. When used in reference to a state of a signal, the term “asserted” means an active state of the signal and the term “negated” means an inactive state of the signal. The actual voltage value or logic state (such as a “1” or a “0”) of the signal depends on whether positive or negative logic is used. Thus, asserted can be either a high voltage or a high logic or a low voltage or low logic depending on whether positive or negative logic is used and negated may be either a low voltage or low state or a high voltage or high logic depending on whether positive or negative logic is used. Herein, a positive logic convention is used, but those skilled in the art understand that a negative logic convention could also be used.

The terms “close”, “near”, and “about” refer to being within minus or plus 10% of an indicated value, unless explicitly specified otherwise. The use of the word “approximately” or “substantially” means that a value of an element has a parameter that is expected to be close to a stated value or position. However, as is well known in the art there are always minor variances that prevent the values or positions from being exactly as stated. It is well established in the art that variances of up to at least ten per cent (10%) (and up to twenty per cent (20%) for some elements including semiconductor doping concentrations and shapes of sidewalls/distances of doped regions) are reasonable variances from the ideal goal of exactly as described.

For simplicity and clarity of the illustration(s), elements in the figures are not necessarily to scale, some of the elements may be exaggerated for illustrative purposes, and the same reference numbers in different figures denote the same elements, unless stated otherwise. Cross hatched regions or cross-hatching in the drawings is used merely to assist in distinguishing boundaries of different regions and does not imply any type of materials. Additionally, descriptions and details of well-known steps and elements may be omitted for simplicity of the description. Neither the figures nor the Detailed Description are intended to limit the scope as claimed. Instead, they merely represent examples of different implementations.

Reference to “one embodiment” or “an embodiment” or an “implementation” means that a particular feature, structure, or characteristic described in connection with the embodiment or implementation is included in at least one implementation. Thus, appearances of the phrases “in one implementation” or “in an implementation” in various places throughout this specification are not necessarily all referring to the same implementation, but in some cases it may. Furthermore, the particular features, structures or characteristics may be combined in any suitable manner and in a wide variety of different implementations, as would be apparent to one of ordinary skill in the art, in one or more implementations.
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor (CGRP), an architecture (see CGRA), an array, or a unit in an array (CGRU). This property distinguishes the system, etc., from field-programmable gate arrays (FPGAs), which may implement digital circuits at the gate level and may therefore be fine-grained configurable.
CGRA—coarse-grained reconfigurable architecture. A data processor architecture that may include one or more arrays (CGR arrays) of CGR units (CGRUs).
CGR Array or ACGRU—an array of CGR units (ACGRUs), coupled with each other through an array-level network (ALN). ACGRU may be coupled with external elements via a top-level network (TLN). A CGR array may physically implement the nodes and edges of a Graph.
Compiler—a translator that processes statements written in a programming language to machine language instructions for a computer processor. A compiler may include multiple stages to operate in multiple steps. Each stage may create or update an intermediate representation (IR) of the translated statements. For the purposes of this disclosure, an assembler that generates configuration data for a CGR processor from low-level so-called assembly language code can also be referred to as a compiler.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms input layer nodes may assign variables, output layer nodes may represent algorithm outcomes, and hidden layer nodes may perform operations on the variables. Edges may represent data (e.g., scalars, vectors, tensors) flowing between operations. In addition to dependencies, the computation graph may reveal which operations and/or expressions can be executed concurrently.
Dataflow Graph or Graph—a computation graph that may include one or more loops that may be nested, and wherein nodes may send messages to nodes in earlier layers to control the dataflow between the layers. For example, a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
CGR unit or CGRU—a circuit that can be configured and reconfigured to locally either or both of store data (e.g., a memory unit or a PMU), or to execute a programmable function (e.g., a compute unit or a PCU). A CGR unit may include hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Dataflow Graph—a computation graph that may include one or more loops that may be nested, and wherein nodes may send messages to nodes in earlier layers to control the dataflow between the layers.
Graph—a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
Datapath—a collection of functional units that perform data processing operations. The functional units may include memory, multiplexers, ALUs, SIMDs, multipliers, registers, buses, etc.
FCMU—fused compute and memory unit—a circuit that may include both a memory unit and a compute unit.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph or graph that may include a producer operator providing its output as an input to a consumer operator. Metapipelines may be nested, that is, producer operators and consumer operators may include other metapipelines.
ML—machine learning.
Multi-Port Memory—A multi-port memory may include one or more arrays of memory cells that allow for concurrent access to the memory from more than one access port. This can be accomplished in several ways, depending on the implementation, including, but not limited to, a multi-port memory array, multiple banks of memory that allow access to the different banks of memory simultaneously, time multiplexing access to the memory cells from the access port, or a combination thereof.
PCU—pattern compute unit—a compute unit that can be configured to repetitively perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining may increase overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines may be hard wired and unchangeable, whereas metapipelines may be configured at the CGR processor, CGR array level, and/or CGR unit level.
Pipeline Stages—a pipeline may be divided into stages that are coupled with one another to form a pipe topology.
PMU—pattern memory unit—a memory unit that can locally store data according to a programmed pattern.
PNR—place and route—the assignment of logical CGR units and associated processing/operations to physical CGR units in an array, and the configuration of communication paths between the physical CGR units.
RAIL—reconfigurable dataflow unit (RDU) abstract intermediate language.
ROB—Re-Order Buffer, A buffer that may be used to put data or instructions back in the original program order after they possibly have gotten out of order.
SIMD—single-instruction multiple-data—an arithmetic logic unit (ALU) that may simultaneously perform a single programmable operation on multiple data elements delivering multiple output results.
TLN—top-level network.

The embodiments or implementations illustrated and described hereinafter may have implementations and/or may be practiced in the absence of any element which is not specifically disclosed herein.

### Implementations

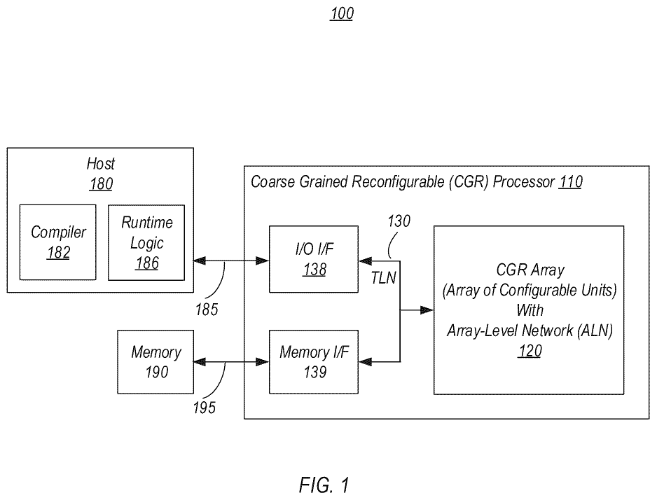

FIG. 1 illustrates a block diagram of an example system 100 including a coarse-grained reconfigurable (CGR) processor (CGRP) 110, a host 180, and a memory 190, in accordance with example embodiments of the disclosure. System 100 may be used to implement ordered delivery of packets from multiple source units to a destination unit in a reconfigurable data processor, as discussed above.

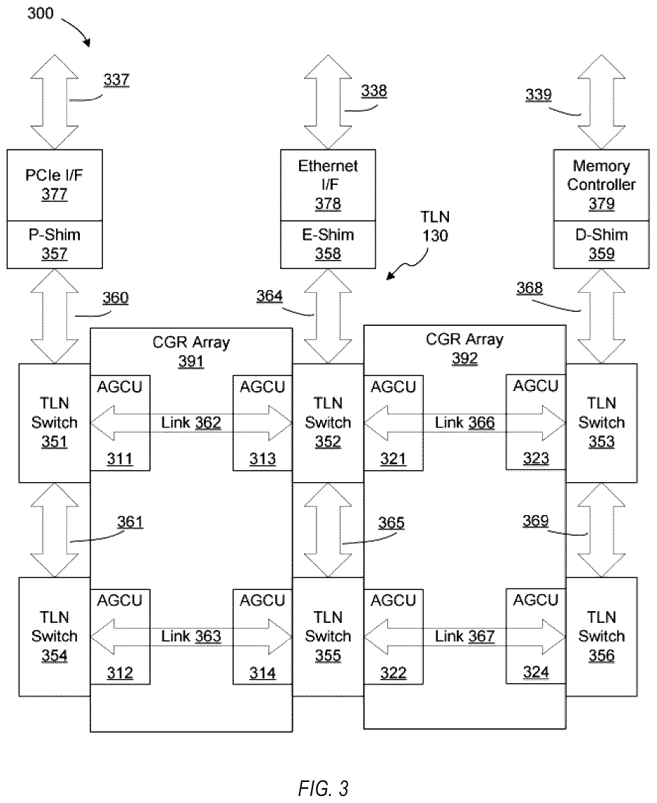

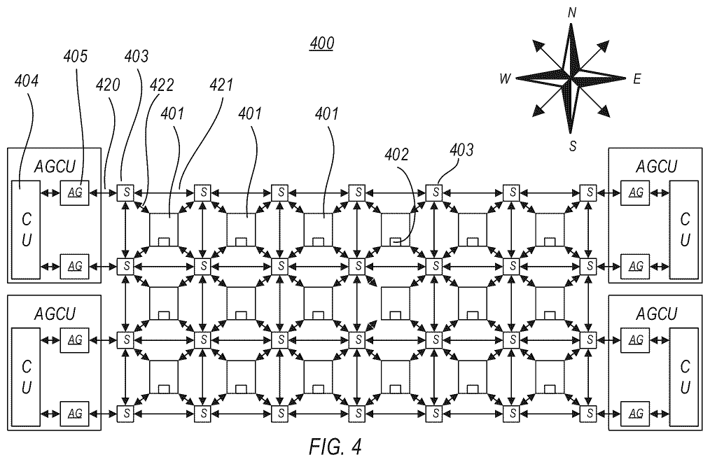

CGR processor (CGRP) 110 may have a coarse-grained reconfigurable architecture (CGRA) and may include an array of CGR units (ACGRUs) 120, such as a CGR array. CGR processor (CGRP) 110 may further include an I/O interface (I/F) 138 and a memory interface (I/F) 139. Array of CGR units (ACGRUs) 120 may be coupled with I/O interface (I/F) 138 and memory interface (I/F) 139 via a top-level network (TLN) 130 that may include a data bus. Host 180 may communicate with I/O interface 138 via a communications link 185, such as for example a system data bus, and memory interface 139 may communicate with memory 190 via a memory bus 195. Additional details regarding the internal structure of CGR processor (CGRP) 110 are provided below with respect to FIGS. 3 and 4.

Array of CGR units (ACGRUs) 120 may include compute units, memory units, and/or fused compute-memory units that may be connected with an array-level network (ALN) 125 to provide circuitry for execution of a graph, such as for example a computation graph or a dataflow graph, that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks, and/or any other procedures and functions that may need serial and/or parallel processing. In some implementations, execution of one or more graphs may involve using multiple units of CGR processor (CGRP) 110. In some implementations, CGR processor (CGRP) 110 may include one or more integrated circuits (ICs). In other implementations, a single IC may span multiple coarsely reconfigurable data processors. In further implementations, CGR processor (CGRP) 110 may include one or more units of array of CGR units (ACGRUs) 120.

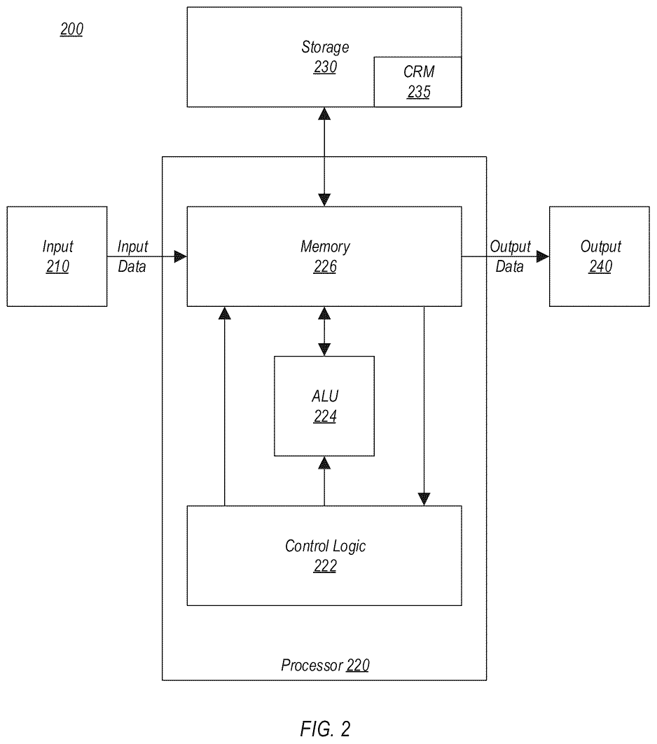

Host 180 may be, or may include, a computer such as further described with reference to FIG. 2. Host 180 may run runtime logic 186, and may also be used to run computer programs, such as a compiler 182 as described herein. In some implementations, compiler 182 may run on a computer 200 as described in FIG. 2, but separate from host 180 and unconnected to CGR processor (CGRP) 110.

CGR processor (CGRP) 110 may accomplish computational tasks by executing a configuration file, such as for example a processor-executable format (PEF) file. A configuration file may correspond to a dataflow graph, or a translation of a dataflow graph, and may further include initialization data. Compiler 182 may compile a high-level program to provide the configuration file. In some implementations, a CGR array or an ACGRU may be configured by programming one or more configuration stores in the CGR units within array 120 with all or parts of the configuration file. A single configuration store may be at the level of CGR processor (CGRP) 110 or the CGR array, or a CGR unit of the CGR array may include an individual configuration store. The configuration file may include configuration data for the CGR array and CGR units in the CGR array, and may link a computation graph to the CGR array. Execution of the configuration file by CGR processor (CGRP) 110 may cause one or more CGR arrays to implement user algorithms and functions in the dataflow graph.

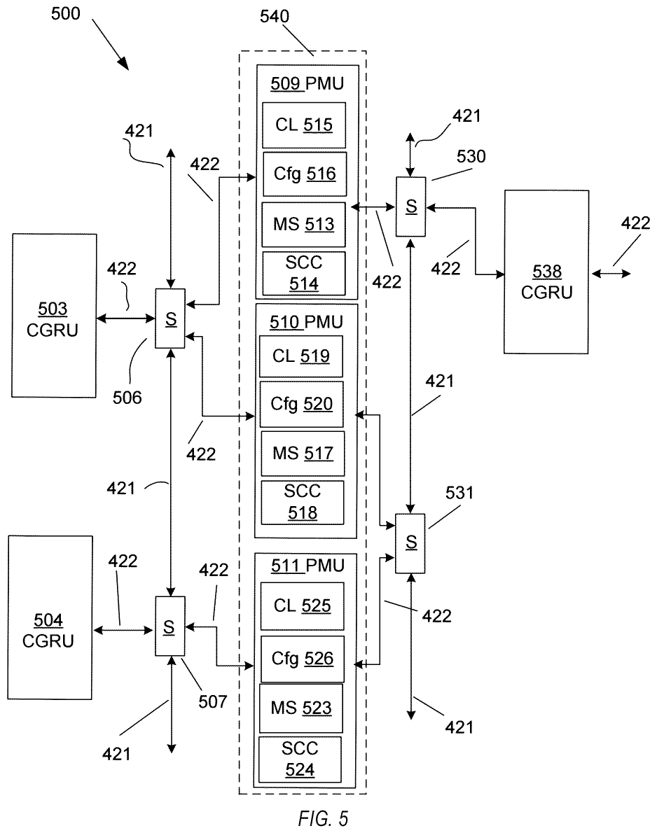

In operation, host 180 may provide configuration data via communications link 185 and I/O interface 138 to CGR processor (CGRP) 110, which may load the configuration data into configuration stores of CGR units in array 120. Once configured, array 120 may execute a dataflow graph by routing packets among the configured CGR units via ALN 125 and TLN 130. In some implementations, multiple source CGR units may transmit packets to a common destination CGR unit over ALN 125, and the destination CGR unit may consume the packets in a defined sequence as discussed further below with respect to FIGS. 5 through 16.

While system 100 is shown with a single CGR processor 110, a single host 180, and a single memory 190, implementations are not so limited. In some implementations, system 100 may include multiple CGR processors, multiple host processors, and/or multiple memory devices coupled via one or more communication links.

FIG. 2 illustrates a block diagram of an example computer 200 that may have an implementation that is substantially the same as at least a portion of host 180 of FIG. 1, in accordance with example embodiments of the disclosure. Computer 200 may include an input device 210, a processor 220, a storage device 230, and an output device 240. Although example computer 200 is shown with a single processor, other implementations may have multiple processors.

Input device 210 may comprise a mouse, a keyboard, a sensor, an input port such as for example a universal serial bus (USB) port, and/or any other input device known in the art. Output device 240 may comprise a monitor, a printer, and/or any other output device known in the art. Furthermore, part or all of input device 210 and output device 240 may be combined in a network interface, such as a Peripheral Component Interconnect Express (PCIe) interface suitable for communicating with CGR processor (CGRP) 110 of FIG. 1. Input device 210 may be coupled with processor 220 to provide input data, which an implementation may store in memory 226.

Processor 220 may be coupled with output device 240 to provide output data from memory 226 and computations from processor 220 to output device 240. Processor 220 may include control logic 222, operable to control memory 226 and arithmetic and logic unit (ALU) 224, and to receive program and configuration data from memory 226. Control logic 222 may further control exchange of data between memory 226 and storage device 230.

Memory 226 may comprise static random-access memory (SRAM), and storage device 230 may comprise dynamic random-access memory (DRAM), flash memory, magnetic disks, optical disks, and/or any other memory type known in the art. At least a part of the memory in storage device 230 may include a non-transitory computer-readable medium (CRM) 235, such as used for storing computer programs and/or configuration files. In some implementations, CRM 235 may store configuration data that, when loaded into CGR processor (CGRP) 110, may configure array 120 to perform methods of ordered packet delivery as described herein.

FIG. 3 illustrates a block diagram of an example reconfigurable data processor (CGRP) 300 that may have an implementation that is substantially the same as CGRP 110 of FIG. 1, including two arrays of configurable units and a top-level network, in accordance with example embodiments of the disclosure. CGRP 300 may have a coarse-grained reconfigurable architecture (CGRA). In this example, CGRP 300 includes two CGR arrays (Array1 391, Array2 392), although other implementations may have any number of arrays or tiles, including a single tile. As will be seen further in the description of FIG. 4, CGR arrays 391 and 392 may each comprise an array of configurable units (ACGRUs) connected by an array-level network, such as for example ALN 125 of FIG. 1. Each of CGR arrays 391 and 392 may have one or more address generation and coalescing units (AGCUs) 311-314 and 321-324. The AGCUs may be nodes on both top-level network 130 and on array-level networks within their respective CGR arrays 391 and 392, and may include resources for routing data among nodes on top-level network 130 and nodes on the array-level network in each CGR array 391 and 392.

CGR arrays 391 and 392 may be coupled to top-level network (TLN) 130 that may include switches 351-356 and links 360-369 that may allow for communication between elements of Array1 391, elements of Array2 392, and shims to other functions of CGR processor 110, including P-Shim 357, E-Shim 358, and D-Shim 359. Other functions of CGR processor (CGRP) 110 may connect to TLN 130 in different implementations, such as additional shims to additional and/or different input/output (I/O) interfaces and memory controllers, and other chip logic such as configuration status registers (CSRs), configuration controllers, or other functions. Data may travel in packets between the devices, including switches 351-356, on links 360-369 of TLN 130. For example, top-level switches 351 and 352 may be connected by a link 362, top-level switches 351 and P-Shim 357 may be connected by a link 360, top-level switches 351 and 354 may be connected by a link 361, and top-level switch 353 and D-Shim 359 may be connected by a link 368.

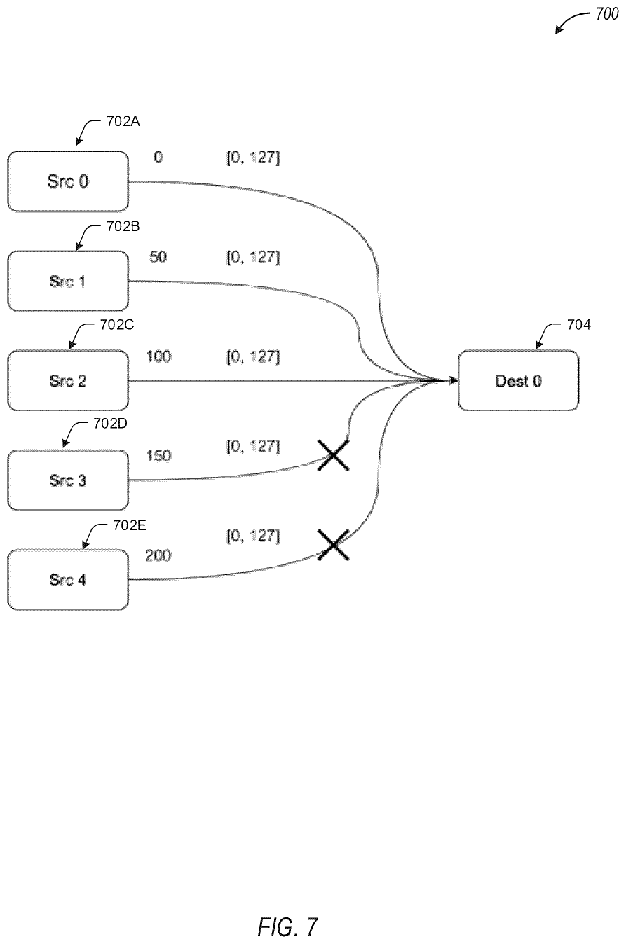

TLN 130 may be a packet-switched mesh network using an array of switches 351-356 for communication between agents. Any routing strategy may be used on TLN 130, depending on the implementation. In some implementations, the various components of TLN 130 may be arranged in a grid and may use a row-column addressing scheme. Such implementations may route a packet first vertically to a designated row and then horizontally to a designated destination. Other implementations may use other network topologies and/or routing strategies for TLN 130. Because packets may traverse different paths through TLN 130, packets originating from different source units may arrive at a common destination in an order different from the order in which they were generated. Additional details regarding ordering of such packets are provided below with respect to FIGS. 7 through 16.

P-Shim 357 may provide an interface between TLN 130 and a PCIe interface 377, which may connect to an external communication link 337. E-Shim 358 may provide an interface between TLN 130 and an Ethernet interface 378, which may connect to an external communication link 338. While P-Shim 357 and E-Shim 358 with associated interfaces 377, 378 and links 337, 338 are shown, implementations may have any number of shims and associated interfaces and links. D-Shim 359 may provide an interface to a memory controller 379, which may have a memory interface 339 and may connect to memory such as memory 190 of FIG. 1. While one D-Shim 359 is shown, implementations may have any number of D-Shims and associated memory controllers and memory interfaces.

Each CGR processor may include an array of CGR units disposed in a configurable interconnect such as an array-level network, and a configuration file may define a dataflow graph including functions in the configurable units and links between the functions in the configurable interconnect. In this manner, the configurable units may act as sources or destinations of data used by other configurable units, providing functional nodes of the graph. Such systems may use external data processing resources not implemented using the configurable array and interconnect, including memory and a processor executing a runtime program, as sources or sinks of data used in the graph.

FIG. 4 illustrates a block diagram of an example array of configurable units (CGR array) 400, including an array of CGR units (ACGRUs) connected in an array-level network (ALN), and including switches and address generation units, in accordance with example embodiments of the disclosure. CGR array 400 may correspond to CGR arrays 391 and 392 described above with reference to FIG. 3. A data processing operation implemented by a CGR array configuration, such as CGR array 400, may comprise multiple graphs or subgraphs specifying data processing operations that may be distributed among and executed by corresponding CGRUs.

CGR array 400 may include one or more types of CGR units (CGRUs) 401, such as for example fused compute and memory units (FCMUs), pattern memory units (PMUs), pattern compute units (PCUs), memory units, and/or compute units. In some implementations, some of CGRUs 401 may be PCUs or PMUs. In other implementations, some of CGRUs 401 may be FCMUs or memory units and compute units, arranged in a checkerboard pattern. In yet other implementations, CGRUs 401 may be arranged in different patterns.

For some transactions within CGR array 400, an initiating CGRU may be referred to as a source, requestor, initiator, or producer CGRU depending on the type of transaction. The source CGRU may initiate various types of transactions to various resources in a remote CGRU. The remote CGRU may be referred to as a destination, consumer, or target CGRU. In some cases, the source CGRU may receive various responses from the destination CGRU. As discussed further below with respect to FIGS. 5 through 16, when multiple source CGRUs transmit packets to a common destination CGRU, the packets may be ordered at the destination using sequence identifiers and a sliding transmission window.

CGRUs 401 may include a configuration store/logic (Cfg) circuit 402 that may include a set of storage and/or control logic, such as for example registers or flip-flops, that may store configuration data. The configuration data may represent a setup and/or control sequence that may facilitate executing a graph. Cfg 402 may also include status information about the CGRU usable to track progress for execution of a graph or sub-graph. Cfg 402 may further include the source of operands and the network parameters for input and output interfaces.

A configuration file for Cfg 402 may include configuration data representing an initial configuration, or starting state, of one or more CGRUs or internal elements of a CGRU that may execute a graph or other high-level program with user algorithms and functions. Program load may be the process of initializing the configuration store (Cfg) with the configuration file for configuring the configuration stores in the CGR array based on the configuration data to facilitate the CGRUs executing the graph or other high-level program. Program load may also involve loading memory units and/or PMUs.

The ALN of CGR array 400 may include switch units or switches(S) 403, and AGCUs that may each include two address generators (AG) 405 and a shared coalescing unit (CU) 404. Switch units(S) 403 may be connected among themselves via interconnects 421 and may also be connected to a CGRU 401 via interconnects 422. Switch units(S) 403 may be coupled with address generators (AG) 405 via interconnects 420. In some implementations, communication channels may be configured as end-to-end connections, and switch units 403 may be CGRUs. In other implementations, switches may route data via available links based on address information in packet headers, and communication channels may be established as and when needed.

The ALN may include one or more kinds of physical data buses, for example a chunk-level vector bus (e.g., 512 bits wide to transmit 512 bits of data), a word-level scalar bus (e.g., 32 bits wide to transmit 32 bits of data), and a control bus. For instance, interconnects 421 between two switches may include a vector bus interconnect with a vector word width, for example 512 bits wide, and a scalar bus interconnect with a scalar word width, for example 32 bits wide, along with a control bus. The control bus may comprise physical lines separate from the data buses in some implementations. In other implementations, the control bus may be implemented using the same physical lines with a separate protocol or in a time-sharing procedure. A control bus may comprise a configurable interconnect that carries multiple control bits on multiple signal routes designated by configuration bits in a CGRU's configuration file in the configuration store, such as in Cfg 402.

Physical data buses may differ in the granularity of data being transferred. In one implementation, a vector bus may carry a transmission that includes 16 channels of 32-bit floating-point data or 32 channels of 16-bit floating-point data (i.e., 512 bits of data) as its payload. An implementation of a scalar bus may have a 32-bit payload and may carry scalar operands or control information. The control bus may carry control handshakes such as tokens and other signals. The vector and scalar buses may be packet-switched, where the packets may include headers that indicate a destination of each packet and other information such as sequence numbers that may be used to reassemble data when the packets are received out of order. Each packet header may contain a destination identifier that identifies the spatial coordinates of the destination switch unit (e.g., the row and column in the array), and an interface identifier that identifies the interface on the destination switch (e.g., North, South, East, West, etc.) used to reach the destination unit.

Each CGRU 401 may have four ports (as illustrated) to interface with switch units 403, or any other number of ports suitable for an ALN. Each port may be suitable for receiving and transmitting data, or a port may be suitable for only receiving or only transmitting data.

A switch unit(S) 403 may have eight interfaces. North, South, East, and West interfaces of a switch unit may be used for links between switch units using interconnects 421. Northeast, Southeast, Northwest, and Southwest interfaces of a switch unit may each be used to make a link with a CGRU 401 using one of interconnects 422. Two switch 403 units in each CGR array quadrant may have links to an AGCU using interconnects 420. The AGCU coalescing unit may arbitrate between the AGs and may process memory requests. Each of the eight interfaces of a switch unit may include a vector interface, a scalar interface, and a control interface to communicate with the vector network, the scalar network, and the control network. In other implementations, a switch unit may have any number of interfaces.

During execution of a graph or subgraph in a CGR array after configuration, data may be sent via one or more switch units and one or more interconnects between the switch units to the CGRUs using the vector bus and vector interface(s) of the one or more switch units on the ALN. A CGR array may comprise at least a part of CGR array 400, and any number of other CGR arrays coupled with CGR array 400.

FIG. 5 illustrates a block diagram of an example array of configurable units (CGR array) 500 including source units and a destination unit coupled by an interconnect network, in accordance with example embodiments of the disclosure. CGR array 500 may be an implementation of at least a portion of CGR array 400 of FIG. 4. CGR array 500 may be configured to execute a graph or sub-graph to implement a defined function.

CGR array 500 may include source CGRUs 503 and 504, PMUs 509, 510, and 511, and a destination CGRU 538. ALN switches(S) 506, 507, 530, and 531 may be implementations of ALN switches(S) 403 described above with reference to FIG. 4. CGRUs 503, 504, and 538 may be any one of the CGRU types described above with reference to FIG. 4. During execution of a graph or sub-graph, source CGRUs, such as for example CGRUs 503 and 504, may transmit packets of a data group to destination CGRU 538 via one or more of the ALN switches. The data group may include packets of vector data, packets of scalar data, or other types of data.

PMUs 509-511 may include respective control logic (CL) circuits 515, 519, and 525 that may be used for address calculation and control of respective memory store (MS) circuits 513, 517, and 523. In some implementations, control logic (CL) circuits 515, 519, and 525 may be configured to calculate any number and combination of concurrently generated read addresses and write addresses to or from MS circuits 513, 517, and 523. PMUs 509-511 may also include respective configuration store/logic circuits or configuration stores (Cfg) 516, 520, and 526 that may be implementations of and may function substantially the same as Cfg circuit 402 described above with reference to FIG. 4. CGRUs 503, 504, and 538 may have similar configuration stores and control circuits.

The Cfg circuits may store unit files of configuration data particular to the respective CGRU or PMU. The Cfg circuits may each include a set of storage locations or control logic, such as for example registers or flip-flops, that may store status usable to facilitate operation of the PMU and respective control logic circuits, or to track progress for execution of a graph or sub-graph. The configuration file data for the Cfg circuits may be loaded therein by a unit configuration load process, such as for example receiving and loading data particular to a CGRU from one or more data buses of interconnects 422. For example, the Cfg circuits may store information or data that represents either initialization data for some of the CGRU or PMU circuits, or the sequence to run a graph or a portion of a graph. The Cfg circuits may also store status information usable to track progress during execution of a graph or sub-graph. Additionally, the Cfg circuits may include instructions to be executed for a CGRU, the source of operands, the number of nested loops, the limits of each loop iterator, and the network parameters for input and output interfaces, such as for example, but not limited to, configuration and/or initialization data for the CL circuits.

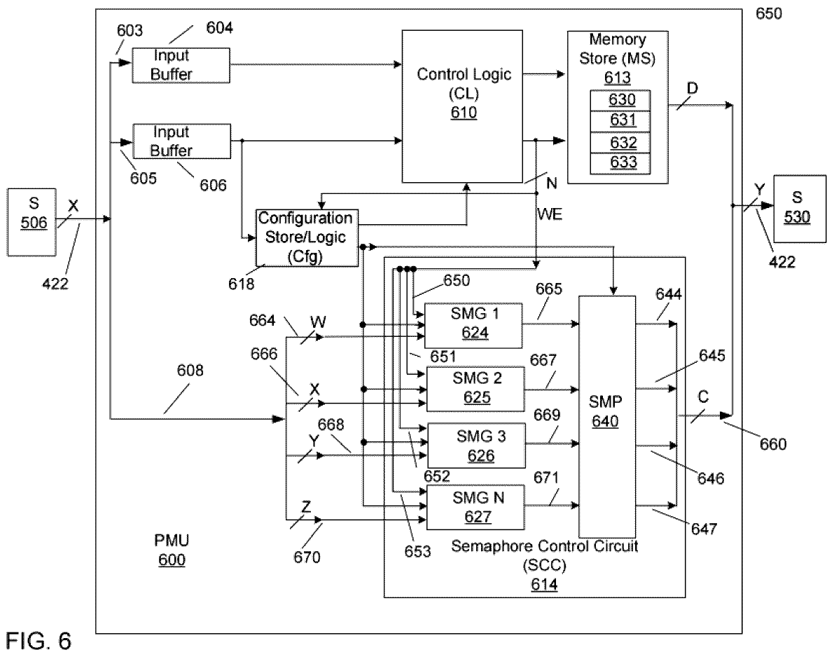

In operation, when multiple source CGRUs, such as CGRUs 503 and 504, transmit packets to a common destination CGRU, such as CGRU 538, the packets may traverse different paths through the ALN switches 506, 507, 530, and 531, and may arrive at destination CGRU 538 in an order different from the order in which they were generated. As discussed further below with respect to FIGS. 7 through 16, the destination CGRU may consume the packets in sequence identifier order regardless of the order in which the packets were received. While two source CGRUs 503 and 504 and one destination CGRU 538 are shown, implementations are not so limited. In some implementations, any number of source CGRUs may transmit packets to one or more destination CGRUs. Additional details regarding the internal structure of a PMU, including input buffers that may be used as reorder buffers, are provided below with respect to FIG. 6.

FIG. 6 illustrates a block diagram of an example pattern memory unit (PMU) 600 including input buffers, control logic, and a memory store, in accordance with example embodiments of the disclosure. PMU 600 may be an implementation of portions of any one or more of the PMUs of CGR array 500 of FIG. 5, and in some implementations may also represent portions of destination CGRU 538 or other CGRUs of FIG. 5 that include input buffer structures.

Input buffers 604 and 606 of PMU 600 may be connected to respective data buses 603 and 605 of interconnect 422. One of buffers 604 or 606 may be connected to a vector bus of interconnect 422 to receive vector data from one of buses 603 or 605, and the other one of buffers 604 or 606 may be connected to a scalar bus of interconnect 422 to receive scalar data from the other one of buses 603 or 605. Buffers 604 and 606 may be implemented as first-in, first-out (FIFO) buffers, as circular buffers, or as any other suitable buffer implementation.

PMU 600 may further include control logic (CL) 610, which may be coupled to input buffers 604 and 606 and may be operable to calculate read addresses and write addresses for a memory store (MS) 613. Memory store (MS) 613 may include one or more memory banks, such as banks 630, 631, 632, and 633, that may be accessed concurrently or independently by control logic 610. PMU 600 may also include a configuration store/logic (Cfg) 618 that may store configuration data particular to PMU 600, including parameters for controlling the behavior of control logic 610 and the addressing of memory store 613 and input buffers 604, 606.

PMU 600 may further include a semaphore control circuit (SCC) 614 that may include one or more semaphore generators (SMGs), such as SMG 1 (624), SMG 2 (625), SMG 3 (626), and SMG N (627), and a semaphore processor (SMP) 640. SCC 614 may coordinate access to memory store 613 and may manage synchronization between producer and consumer operations within PMU 600. In some implementations, SCC 614 may generate and process control signals that may be used to gate read and write operations to memory store 613 and input buffers 604, 606.

PMU 600 may be coupled to ALN switches, such as switch(S) 506 via interconnect 422 on an input side and switch(S) 530 via interconnect 422 on an output side, as illustrated. In some implementations, PMU 600 may receive packets from multiple source CGRUs through one or more of its input buffers 604, 606 and may provide data from memory store 613 to downstream CGRUs via the output-side interconnect.

Referring to FIG. 5 and FIG. 6, source CGRUs 503 and 504 may transmit packets to destination CGRU 538. It may be desirable that the packets have an ordered sequence at the destination. In some implementations, one or more of the input buffers of a destination, such as for example destination CGRU 538, may have input buffers similar to buffers 604 and 606 of FIG. 6. In some implementations, the input buffers may be FIFO buffers. In other implementations, the input buffers may be circular buffers. In still other implementations, the input buffers may be direct-mapped structures in which a sequence identifier or a portion thereof may serve as a write address.

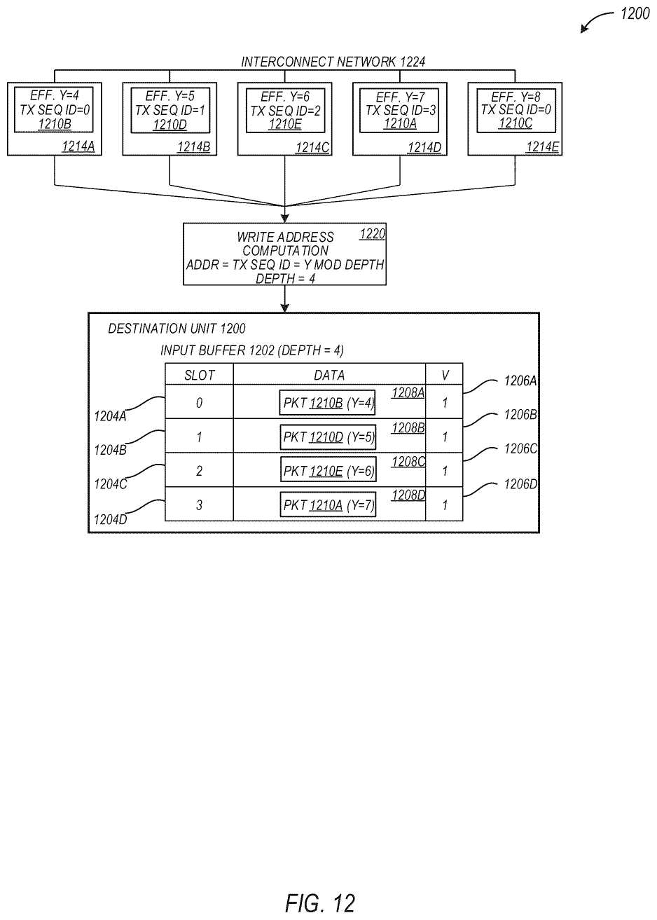

In some implementations, at least a portion of one or more of the input buffers of a destination CGRU, such as destination CGRU 538, may be used to implement a reorder buffer. Rather than storing incoming packets in arrival order, the input buffer may store each received packet at a location addressed by a sequence identifier included in the packet. The destination CGRU may then read packets from the input buffer in order of the sequence identifiers, regardless of the order in which those packets arrived over the interconnect network. In some implementations, the mapping from sequence identifier to buffer location may comprise a modular reduction of the sequence identifier by the depth of the input buffer. Additional details regarding sequence-identifier-addressed buffering are provided below with respect to FIG. 12.

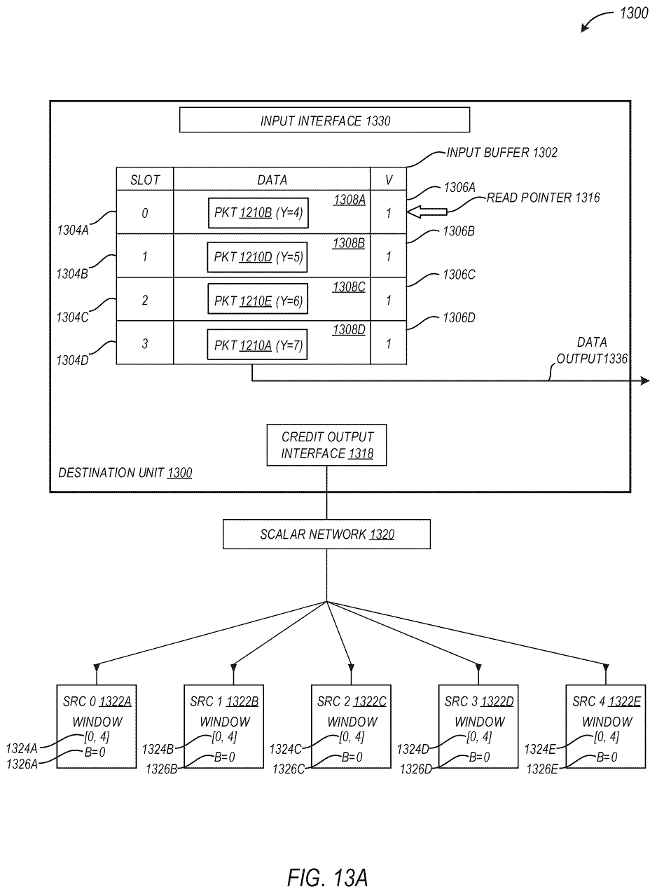

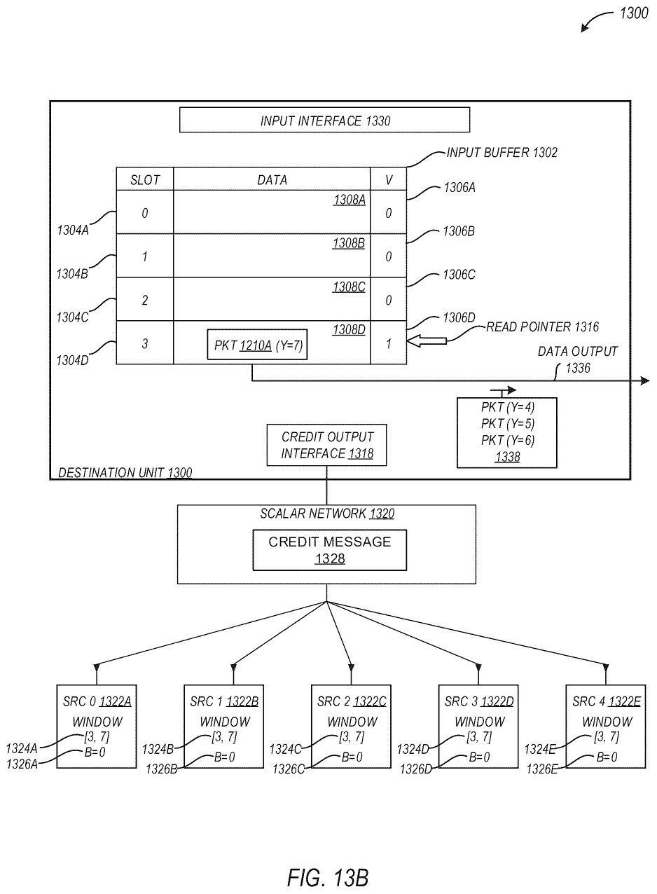

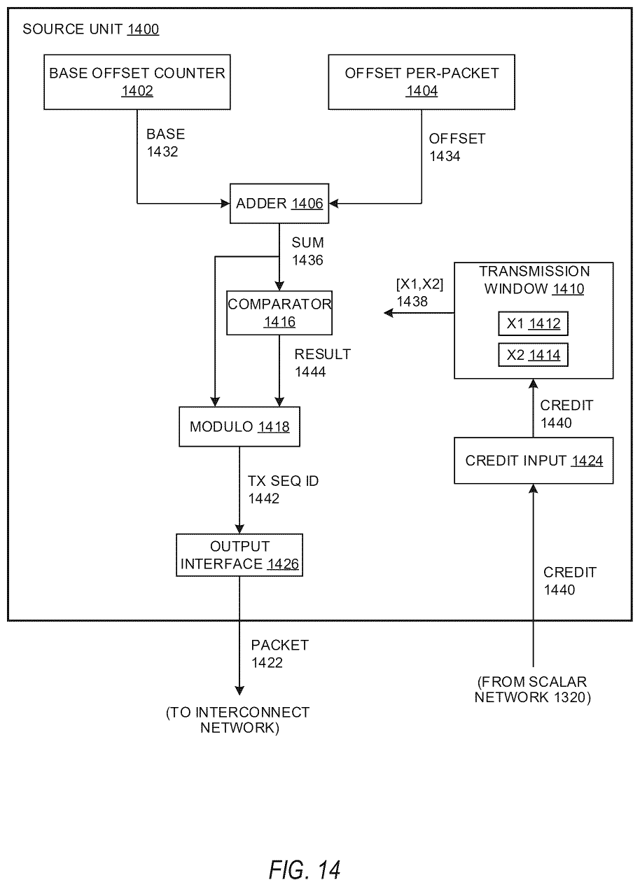

To coordinate transmission timing across multiple source CGRUs and to prevent buffer overflow at the destination, each source CGRU may maintain a transmission window defining a range of sequence identifiers. A source CGRU may transmit a packet when the sequence identifier of the packet is within the transmission window, and may withhold transmission when the sequence identifier is outside the window. The destination CGRU may consume packets in sequence identifier order and, upon consuming a quantity of consecutive packets, may transmit a credit to each of the source CGRUs, causing the source CGRUs to advance their respective transmission windows. Additional details regarding the sliding transmission window mechanism are provided below with respect to FIGS. 7 through 11. Additional details regarding the credit cycle and transmission window advancement are provided below with respect to FIGS. 13A and 13B. Additional details regarding the source-side computation of sequence identifiers and comparison against the transmission window are provided below with respect to FIG. 14.

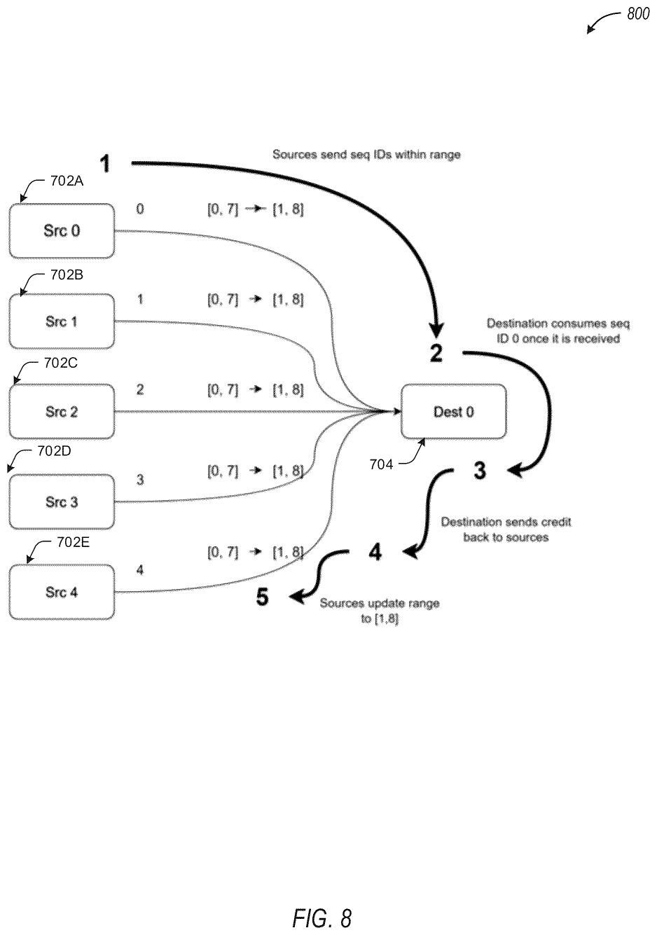

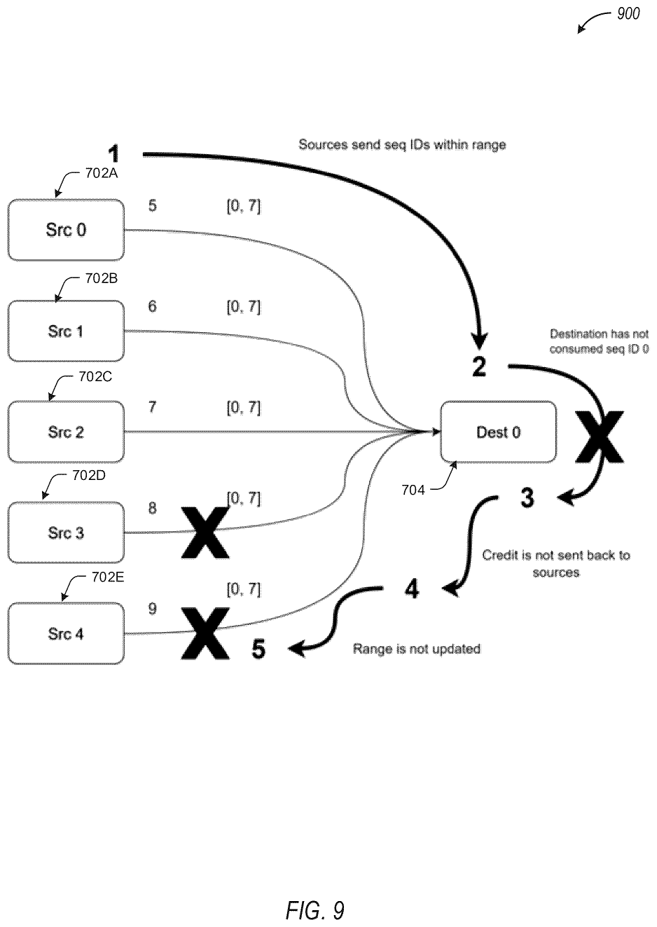

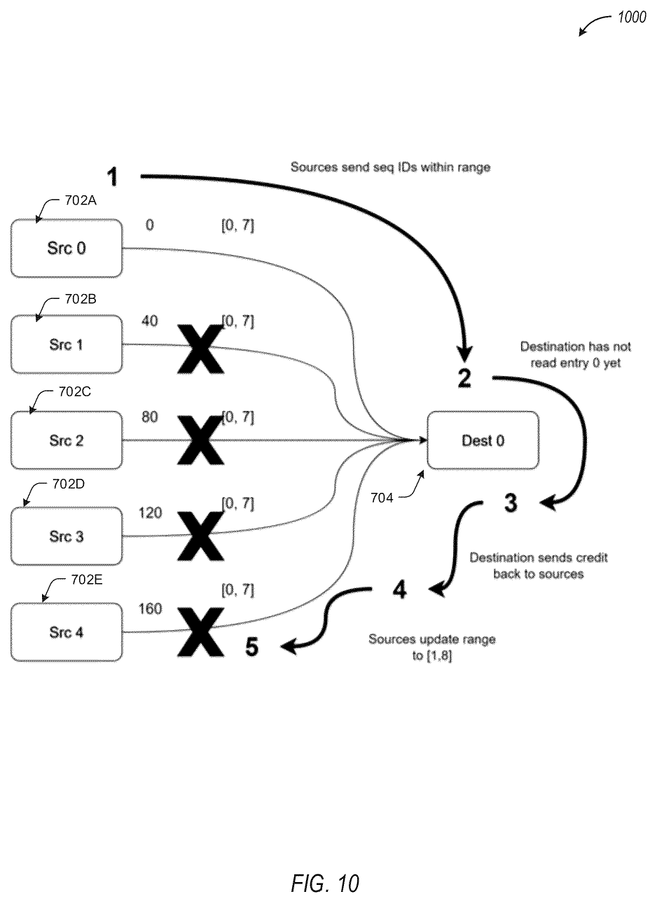

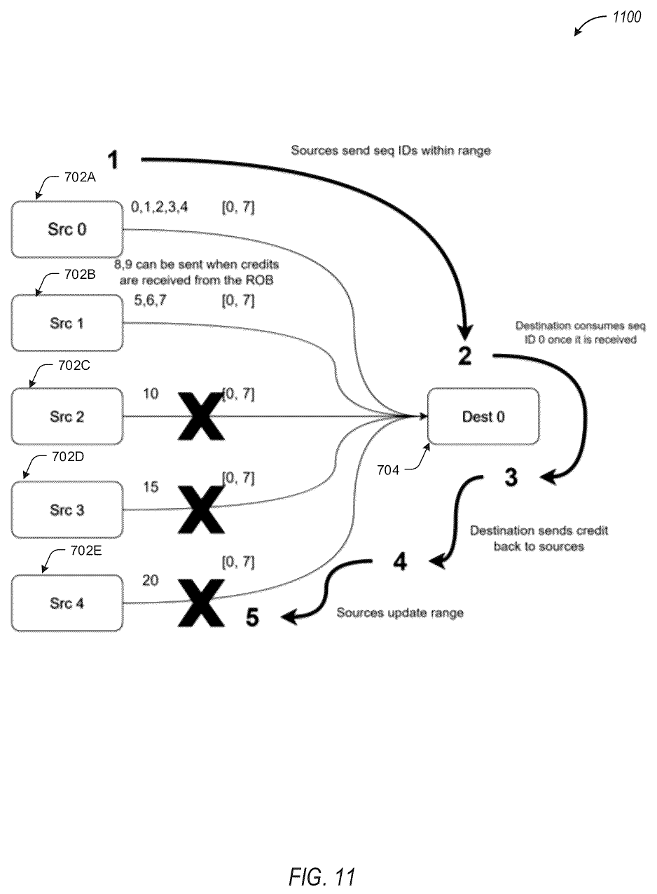

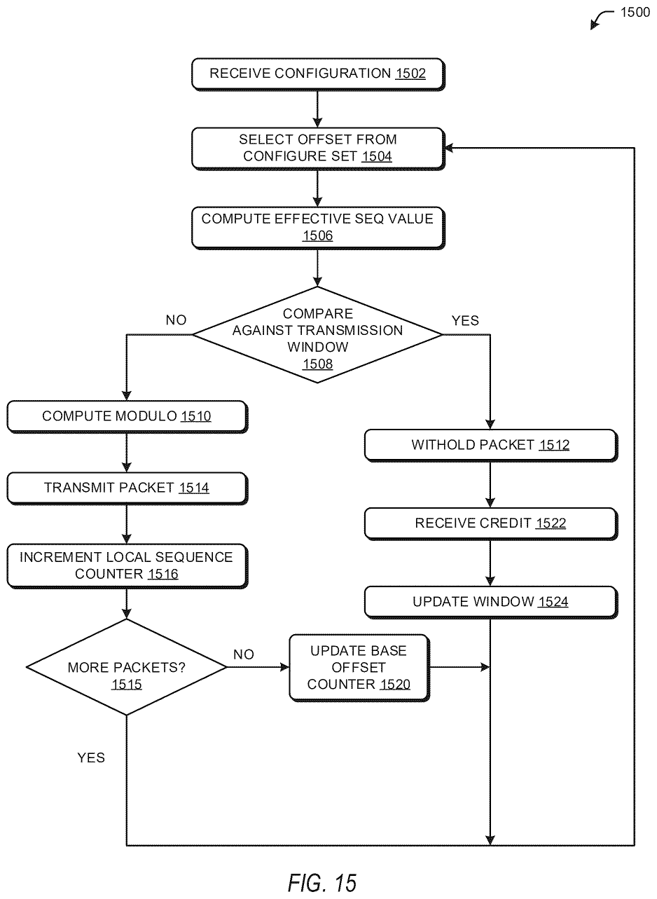

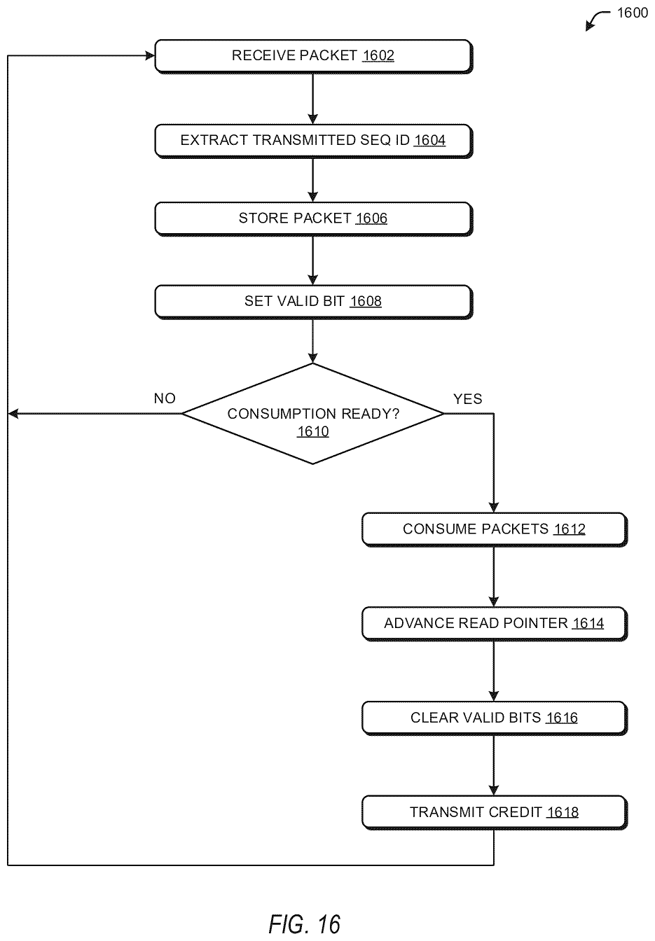

FIG. 7 illustrates a diagram of an example many-to-one packet transmission configuration 700 including a plurality of source units transmitting packets to a destination unit with a sliding transmission window, in accordance with example embodiments of the disclosure. Configuration 700 may illustrate an example of the many-to-one communication pattern discussed above, in which multiple source units transmit packets to a common destination unit over an interconnect network such as ALN 125 of FIG. 1 or the array-level network of CGR array 500 of FIG. 5. As illustrated, configuration 700 may include five source units 702A, 702B, 702C, 702D, and 702E (labeled Src 0, Src 1, Src 2, Src 3, and Src 4, respectively) and a destination unit 704 (labeled Dest 0). Source units 702A-702E may correspond to source CGRUs, such as CGRUs 503 and 504 of FIG. 5, and destination unit 704 may correspond to a destination CGRU, such as CGRU 538 of FIG. 5. Although five source units and one destination unit are shown, implementations are not so limited. In some implementations, any number of source units may transmit packets to one or more destination units. In some implementations, a source unit may be a pattern compute unit (PCU), a pattern memory unit (PMU), a fused compute and memory unit (FCMU), or any other configurable unit type described above with reference to FIG. 4. Similarly, destination unit 704 may be any configurable unit type that includes an input buffer, such as for example an input buffer similar to input buffers 604 and 606 of PMU 600 described above with reference to FIG. 6. Each source unit 702A-702E may be configured to transmit packets including sequence identifiers to destination unit 704. In the example shown, each source unit 702A-702E may have a respective sequence identifier assigned at configuration time: source unit 702A may have a sequence identifier of 0, source unit 702B may have a sequence identifier of 50, source unit 702C may have a sequence identifier of 100, source unit 702D may have a sequence identifier of 150, and source unit 702E may have a sequence identifier of 200. The sequence identifiers may indicate the order in which destination unit 704 is to consume the corresponding packets, regardless of the order in which the packets arrive at destination unit 704 over the interconnect network. Each source unit 702A-702E may maintain a transmission window defining a range of sequence identifiers that are valid for transmission. In the example shown, each source unit 702A-702E may maintain a coherent transmission window of [0, 127]. A source unit may be configured to transmit a packet when the sequence identifier of the packet is within the transmission window, and to withhold transmission when the sequence identifier is outside the transmission window. As illustrated, source units 702A, 702B, and 702C, having respective sequence identifiers of 0, 50, and 100, may each have a sequence identifier that falls within the transmission window [0, 127], and may therefore transmit their respective packets to destination unit 704. Source units 702D and 702E, having respective sequence identifiers of 150 and 200, may each have a sequence identifier that falls outside the transmission window [0, 127], and may therefore be withheld from transmitting their respective packets until the transmission window advances to include those sequence identifiers. The withholding of source units 702D and 702E may prevent destination unit 704 from receiving packets with sequence identifiers for which the corresponding input buffer locations may not yet be available. Because destination unit 704 may store incoming packets at input buffer locations addressed by the transmitted sequence identifiers, as discussed further below with respect to FIG. 12, transmitting a packet with a sequence identifier that maps to an occupied buffer location may overwrite unconsumed data. The transmission window may thus serve as a flow-control mechanism that prevents such buffer aliasing. In some implementations, the size of the transmission window may correspond to the depth of the input buffer at destination unit 704. In other implementations, the transmission window may be smaller than the buffer depth to provide a guard band, or may be configurable based on the particular dataflow operation being executed. The per-packet sequence identifiers shown in FIG. 7 may be effective sequence values computed from a base offset counter and a per-packet offset, as discussed further below with respect to FIG. 14. In some implementations, the transmitted sequence identifier placed in the packet header may be derived from the effective sequence value by a modular reduction by the buffer depth, as discussed further below with respect to FIG. 12. In some implementations, the source units 702A-702E may maintain their respective transmission windows coherently, such that each source unit maintains the same range of valid sequence identifiers at any given time. The transmission windows may be advanced in response to receiving a credit from destination unit 704, as discussed further below with respect to FIGS. 8, 13A, and 13B. While the example of FIG. 7 shows a configuration in which individual source units each transmit a single packet per iteration, implementations are not so limited. In some implementations, a source unit may transmit multiple packets per iteration, each with a different sequence identifier, as illustrated in FIG. 11. FIGS. 8 through 11 illustrate various interleaving configurations that may arise depending on the relationship between the number of packets per source, the number of source units, and the depth of the reorder buffer at the destination unit. FIGS. 8 and 9 illustrate fine-grained interleaving configurations in which each source unit may transmit a small number of packets (e.g., one packet per source), and FIGS. 10 and 11 illustrate coarse-grained interleaving configurations in which each source unit may transmit a larger number of packets. In each case, the sliding transmission window may coordinate which source units are permitted to transmit at any given time. FIG. 8 illustrates a diagram of an example fine-grained interleaving configuration 800 showing a credit cycle between destination unit 704 and a plurality of source units 702A-702E, in accordance with example embodiments of the disclosure. Configuration 800 may illustrate an example of fine-grained interleaving in which a reorder buffer at destination unit 704 may have a depth of eight entries, and each source unit 702A-702E may transmit one packet per iteration. As illustrated, configuration 800 may depict a sequence of five steps, labeled 1 through 5, that together may form a credit cycle between source units 702A-702E and destination unit 704. At step 1, source units 702A-702E may send packets with sequence identifiers that are within the current transmission window. In the example shown, source unit 702A may transmit a packet with a sequence identifier of 0, source unit 702B may transmit a packet with a sequence identifier of 1, source unit 702C may transmit a packet with a sequence identifier of 2, source unit 702D may transmit a packet with a sequence identifier of 3, and source unit 702E may transmit a packet with a sequence identifier of 4. Each source unit 702A-702E may maintain a transmission window of [0, 7] at the start of the credit cycle. Because the sequence identifiers 0, 1, 2, 3, and 4 may each fall within the range [0, 7], all five source units may be permitted to transmit concurrently. The packets may traverse the interconnect network and may arrive at destination unit 704 in any order. At step 2, destination unit 704 may consume the packet with sequence identifier 0 once that packet has been received and stored at the corresponding input buffer location. Destination unit 704 may consume packets in sequence identifier order beginning from a read pointer, and may determine that a packet is available for consumption by checking a valid indicator, such as a valid bit, associated with the buffer location addressed by the current read pointer. In some implementations, destination unit 704 may wait until a predetermined quantity of consecutive packets, starting at the read pointer, have been received before consuming them as a group. At step 3, destination unit 704 may transmit a credit back to source units 702A-702E. The credit may indicate that destination unit 704 has consumed a quantity of packets in sequence identifier order, and that the corresponding input buffer locations are now available for reuse. In some implementations, the credit may be transmitted as a multicast message on a scalar network of the interconnect network, such that a single credit message may cause all source units 702A-702E to receive the credit simultaneously. In other implementations, destination unit 704 may transmit individual credit messages to each source unit. At step 4, the credit may propagate from destination unit 704 to each of source units 702A-702E over the scalar network or other suitable control network. At step 5, in response to receiving the credit, each source unit 702A-702E may advance its transmission window. In the example shown, the transmission windows at all source units may advance from [0, 7] to [1, 8]. Advancing the transmission window may comprise incrementing a minimum value and a maximum value of the range by the quantity of packets consumed by destination unit 704. The advanced transmission window [1, 8] may now include sequence identifiers that were previously outside the valid range, permitting source units to transmit packets with those newly included sequence identifiers in a subsequent credit cycle. The credit cycle illustrated in FIG. 8 may repeat continuously during execution of a dataflow operation. Each cycle may free one or more buffer locations at destination unit 704 and may advance the transmission windows at source units 702A-702E, permitting additional packets to be transmitted. Because all source units may maintain a coherent transmission window, the window may advance uniformly across all source units in response to a single credit message. Additional details regarding the internal structure of the destination unit, including the input buffer, valid bits, and read pointer, are provided below with respect to FIGS. 13A and 13B. FIG. 9 illustrates a diagram of an example transmission configuration 900 showing source units withheld from transmitting when sequence identifiers are outside a transmission window, in accordance with example embodiments of the disclosure. Configuration 900 may illustrate a scenario in which not all source units are able to transmit, and in which the destination unit has not yet consumed previously received packets, thereby preventing the transmission window from advancing. As illustrated, configuration 900 may depict a sequence of five steps, labeled 1 through 5, that may illustrate the behavior of the sliding transmission window when destination unit 704 has not consumed the packet at the head of the reorder buffer. At step 1, source units 702A-702E may attempt to send packets with their respective sequence identifiers. In the example shown, source unit 702A may have a sequence identifier of 5, source unit 702B may have a sequence identifier of 6, source unit 702C may have a sequence identifier of 7, source unit 702D may have a sequence identifier of 8, and source unit 702E may have a sequence identifier of 9. Each source unit 702A-702E may maintain a transmission window of [0, 7]. Because the sequence identifiers of source units 702A, 702B, and 702C (5, 6, and 7, respectively) may fall within the range [0, 7], those source units may transmit their respective packets to destination unit 704. However, the sequence identifiers of source units 702D and 702E (8 and 9, respectively) may fall outside the range [0, 7], and those source units may therefore be withheld from transmitting. At step 2, destination unit 704 may have not yet consumed the packet with sequence identifier 0. The packet with sequence identifier 0 may occupy a buffer location at the read pointer of the input buffer. Until that packet is consumed, destination unit 704 may not advance its read pointer, and may not free the corresponding buffer location for reuse. In some implementations, destination unit 704 may be waiting for the packet with sequence identifier 0 to arrive over the interconnect network. In other implementations, the packet may have arrived but destination unit 704 may be waiting for a predetermined quantity of consecutive valid entries before consuming. At step 3, because destination unit 704 may have not consumed the requisite quantity of consecutive packets, destination unit 704 may not transmit a credit to source units 702A-702E. The absence of a credit may mean that no buffer locations are freed and no new sequence identifiers are added to the valid range. At step 4, because no credit may have been transmitted, the credit return path from destination unit 704 to source units 702A-702E may remain idle. At step 5, because no credit may have been received, the transmission windows at source units 702A-702E may not be updated. The transmission windows may remain at [0, 7], and source units 702D and 702E may continue to be withheld from transmitting. Configuration 900 may illustrate how the sliding transmission window may prevent buffer aliasing at destination unit 704. In the example shown, if source unit 702D were permitted to transmit a packet with sequence identifier 8, and if the reorder buffer has a depth of 8, then the modular reduction of sequence identifier 8 by the buffer depth (8 mod 8=0) would map to buffer location 0 (e.g., the same location occupied by the unconsumed packet with sequence identifier 0). Transmitting the packet with sequence identifier 8 before the packet with sequence identifier 0 has been consumed would overwrite the unconsumed packet and corrupt the ordering. By withholding source unit 702D until the transmission window advances past sequence identifier 8, the sliding window mechanism may prevent this aliasing condition. Once destination unit 704 consumes the packet at sequence identifier 0 and transmits a credit, the transmission windows may advance, and source units 702D and 702E may then be permitted to transmit. This interaction between the credit cycle and the transmission window may thus operate such that no source unit transmits a packet whose sequence identifier maps to an occupied buffer location. FIG. 10 illustrates a diagram of an example coarse-grained interleaving configuration 1000 in which an interleaving factor may exceed a reorder buffer size, in accordance with example embodiments of the disclosure. Configuration 1000 may illustrate a scenario in which each source unit may be assigned a block of consecutive sequence identifiers (an interleaving factor), and the block size may be larger than the depth of the reorder buffer at destination unit 704. As illustrated, configuration 1000 may depict a sequence of five steps, labeled 1 through 5, and may include five source units 702A-702E and destination unit 704. In the example shown, the reorder buffer at destination unit 704 may have a depth of 8 entries, and an interleaving factor of 40 may be used, meaning each source unit may be assigned 40 consecutive sequence identifiers. Source unit 702A may have a starting sequence identifier of 0, source unit 702B may have a starting sequence identifier of 40, source unit 702C may have a starting sequence identifier of 80, source unit 702D may have a starting sequence identifier of 120, and source unit 702E may have a starting sequence identifier of 160. At step 1, each source unit 702A-702E may evaluate whether its sequence identifier falls within the current transmission window of [0, 7]. Because the sequence identifier of source unit 702A (0) may fall within the range [0, 7], source unit 702A may be permitted to transmit. Source units 702B, 702C, 702D, and 702E, having respective starting sequence identifiers of 40, 80, 120, and 160, may each have a sequence identifier that falls outside the transmission window, and may therefore be withheld from transmitting. At step 2, destination unit 704 may not have read the entry at buffer location 0 yet. Once destination unit 704 receives and consumes the packet from source unit 702A and any other packets with sequence identifiers within the current window, destination unit 704 may proceed to transmit a credit. At step 3, destination unit 704 may transmit a credit back to source units 702A-702E indicating the quantity of packets consumed. At step 4, the credit may propagate to each source unit 702A-702E. At step 5, in response to receiving the credit, each source unit 702A-702E may advance its transmission window. In the example shown, the transmission windows may advance from [0, 7] to [1, 8]. However, even after the window advances to [1, 8], the sequence identifiers of source units 702B through 702E (40, 80, 120, and 160) may still fall outside the updated range. As a result, source units 702B through 702E may continue to be withheld from transmitting. Configuration 1000 may illustrate a characteristic of coarse-grained interleaving in which the interleaving factor (40) may be much greater than the reorder buffer size (8). In this configuration, multiple source units may not be able to transmit packets concurrently, because the sequence identifiers assigned to different source units may be spaced far apart relative to the transmission window. Source unit 702A may transmit its block of packets (e.g., sequence identifiers 0 through 39), and the transmission window may advance through multiple credit cycles as destination unit 704 consumes those packets. Once the transmission window has advanced sufficiently to encompass the starting sequence identifier of source unit 702B (40), source unit 702B begin transmitting. This serialization may reduce the effective concurrency of the many-to-one communication pattern relative to fine-grained interleaving configurations such as those shown in FIG. 8, but may be appropriate for workloads in which each source unit produces a large block of sequential data, such as contiguous rows or columns of a matrix or contiguous regions of a tensor. In some implementations, the interleaving factor may be a configurable parameter set at compile time based on the dataflow operation and the number of source units. In other implementations, the interleaving factor may be determined dynamically based on runtime conditions. FIG. 11 illustrates a diagram of an example coarse-grained interleaving configuration 1100 in which an interleaving factor may be less than a reorder buffer size, in accordance with example embodiments of the disclosure. Configuration 1100 may illustrate a scenario in which each source unit may be assigned a block of consecutive sequence identifiers, and the block size may be smaller than the depth of the reorder buffer at destination unit 704, such that multiple source units may have sequence identifiers that partially or fully fall within the transmission window simultaneously. As illustrated, configuration 1100 may depict a sequence of five steps, labeled 1 through 5, and may include five source units 702A-702E and destination unit 704. In the example shown, the reorder buffer at destination unit 704 may have a depth of 8 entries, and an interleaving factor of 5 may be used, meaning each source unit may be assigned 5 consecutive sequence identifiers. Source unit 702A may be assigned sequence identifiers 0, 1, 2, 3, and 4. Source unit 702B may be assigned sequence identifiers 5, 6, 7, 8, and 9. Source unit 702C may have a starting sequence identifier of 10, source unit 702D may have a starting sequence identifier of 15, and source unit 702E may have a starting sequence identifier of 20. At step 1, each source unit 702A-702E may evaluate whether its respective sequence identifiers fall within the current transmission window of [0, 7]. Source unit 702A may have sequence identifiers 0, 1, 2, 3, and 4, all of which may fall within the range [0, 7]. Source unit 702A may therefore transmit all five of its packets without waiting for credits from destination unit 704. Source unit 702B may have sequence identifiers 5, 6, 7, 8, and 9. Sequence identifiers 5, 6, and 7 may fall within the range [0, 7], and source unit 702B may transmit packets with those sequence identifiers. However, sequence identifiers 8 and 9 may fall outside the range [0, 7], and source unit 702B may be withheld from transmitting those remaining packets until credits are received from the reorder buffer at destination unit 704 and the transmission window advances to include those sequence identifiers. Source units 702C, 702D, and 702E, having respective starting sequence identifiers of 10, 15, and 20, may each have sequence identifiers that fall entirely outside the transmission window [0, 7], and may therefore be withheld from transmitting any packets. At step 2, destination unit 704 may consume the packet with sequence identifier 0 once it has been received at the corresponding input buffer location. Destination unit 704 may then continue to consume packets in sequence identifier order as consecutive valid entries become available. At step 3, upon consuming a predetermined quantity of consecutive packets, destination unit 704 may transmit a credit back to source units 702A-702E. At step 4, the credit may propagate to each source unit 702A-702E. At step 5, in response to receiving the credit, each source unit 702A-702E may advance its transmission window. The updated transmission window may now include sequence identifiers 8 and 9, permitting source unit 702B to transmit its remaining packets. Depending on the quantity of packets consumed and the resulting window advancement, the updated window may also begin to include sequence identifiers assigned to source unit 702C, permitting source unit 702C to begin transmitting. Configuration 1100 may illustrate a characteristic of coarse-grained interleaving in which the interleaving factor (5) may be less than the reorder buffer size (8). In this configuration, multiple source units may have sequence identifiers that partially overlap with the transmission window, such that more than one source unit may transmit packets concurrently. As shown, source unit 702A may transmit all five of its packets concurrently with source unit 702B transmitting three of its five packets. This partial overlap may provide greater concurrency than the configuration of FIG. 10, in which one source unit may transmit at a time, while still enforcing the ordering constraint that no source unit may transmit a packet whose sequence identifier falls outside the current transmission window. In some implementations, the interleaving factor may be selected by a compiler based on the number of source units, the depth of the reorder buffer, and the desired degree of concurrency. A smaller interleaving factor relative to the reorder buffer depth may permit more source units to transmit concurrently, while a larger interleaving factor may simplify the assignment of sequence identifiers when each source unit produces a large block of sequential data. The relationship between interleaving factor and reorder buffer size may thus represent a configurable tradeoff between transmission concurrency and per-source block size. Additional details regarding the write-addressing mechanism by which destination unit 704 may store packets at input buffer locations addressed by transmitted sequence identifiers are provided below with respect to FIG. 12. Additional details regarding the credit cycle, including the state of the input buffer before and after consumption of packets, are provided below with respect to FIGS. 13A and 13B. Additional details regarding the computation of effective sequence values and the comparison against the transmission window at each source unit are provided below with respect to FIG. 14. FIG. 12 illustrates a block diagram of an example destination unit 1200 showing packets written into an input buffer at locations addressed by transmitted sequence identifiers, in accordance with example embodiments of the disclosure. Destination unit 1200 may correspond to destination unit 704 of FIGS. 7 through 11, or to destination CGRU 538 of FIG. 5. FIG. 12 may illustrate the write-addressing mechanism by which packets arriving from an interconnect network may be stored in the input buffer at locations determined by the transmitted sequence identifiers carried in the packets, rather than in arrival order. As illustrated, a plurality of packets may arrive at destination unit 1200 from an interconnect network 1224 via receive interfaces 1214A, 1214B, 1214C, 1214D, and 1214E. Interconnect network 1224 may correspond to the array-level network (ALN) of CGR array 400 of FIG. 4, or to any other packet-switched interconnect network coupling source units to destination unit 1200. Each receive interface 1214A-1214E may receive a respective packet from a respective source unit. In some implementations, destination unit 1200 may include fewer or more receive interfaces than shown, and multiple packets may arrive through a single receive interface at different times. Each packet arriving at destination unit 1200 may be associated with an effective sequence value (Y) computed at the source unit, and may carry a transmitted sequence identifier (TX SEQ ID) in its packet header. For purposes of illustration, FIG. 12 also associates each packet with an effective sequence value (Y) that may be maintained internally at a corresponding source unit and from which the TX SEQ ID may be derived. In the example shown, five packets may be in transit or arriving: packet 1210B may be associated with an effective sequence value Y=4 and a transmitted sequence identifier TX SEQ ID=0; packet 1210D may be associated with an effective sequence value Y=5 and a transmitted sequence identifier TX SEQ ID=1; packet 1210E may be associated with an effective sequence value Y=6 and a transmitted sequence identifier TX SEQ ID=2; packet 1210A may be associated with an effective sequence value Y=7 and a transmitted sequence identifier TX SEQ ID=3; and packet 1210C may be associated with an effective sequence value Y=8 and a transmitted sequence identifier TX SEQ ID=0. The effective sequence value may be a wider value maintained internally at the source unit, as discussed further below with respect to FIG. 14, while the transmitted sequence identifier may be a narrower value derived from the effective sequence value and placed in the packet header for transmission over interconnect network 1224. Destination unit 1200 may include a write address computation 1220 that may determine a write address for each arriving packet based on the transmitted sequence identifier carried in the packet. In the example shown, write address computation 1220 may implement the relationship ADDR=TX SEQ ID, where TX SEQ ID may be derived at the source unit as a modular reduction of an effective sequence value, such as TX SEQ ID=(Y MOD DEPTH), and where DEPTH may be the number of entries in input buffer 1202. Because the transmitted sequence identifier may itself be the result of this modular reduction (as computed at the source unit), the transmitted sequence identifier may serve directly as the write address in some implementations. Destination unit 1200 may include an input buffer 1202 having a depth of 4 entries in the example shown. Input buffer 1202 may comprise a plurality of buffer entries, each entry including a data field and a valid indicator. As illustrated, input buffer 1202 may include buffer entries 1204A, 1204B, 1204C, and 1204D corresponding to buffer slots 0, 1, 2, and 3, respectively. Each buffer entry may have a respective valid indicator 1206A, 1206B, 1206C, and 1206D, and a respective data field 1208A, 1208B, 1208C, and 1208D. The valid indicator for a buffer entry may indicate whether a packet has been received and stored at that location. In some implementations, the valid indicator may comprise a valid bit. In the example shown, four packets may have been received and stored in input buffer 1202. Packet 1210B, having an effective sequence value Y=4, may have been stored at buffer entry 1204A (slot 0), because Y MOD DEPTH=4 MOD 4=0. The valid indicator 1206A for slot 0 may be set to 1, indicating that a valid packet occupies that location. Packet 1210D, having an effective sequence value Y=5, may have been stored at buffer entry 1204B (slot 1), because 5 MOD 4=1, and valid indicator 1206B may be set to 1. Packet 1210E, having an effective sequence value Y=6, may have been stored at buffer entry 1204C (slot 2), because 6 MOD 4=2, and valid indicator 1206C may be set to 1. Packet 1210A, having an effective sequence value Y=7, may have been stored at buffer entry 1204D (slot 3), because 7 MOD 4=3, and valid indicator 1206D may be set to 1. Although the packets may have arrived at destination unit 1200 in any order over interconnect network 1224, the packets may now occupy buffer entries in sequence identifier order, because each packet was written to the buffer location addressed by its transmitted sequence identifier. FIG. 12 also illustrates a potential aliasing condition. Packet 1210C may have an effective sequence value Y=8 and a transmitted sequence identifier TX SEQ ID=0, because 8 MOD 4=0. Packet 1210C may thus map to buffer slot 0 (e.g., the same slot occupied by packet 1210B (Y=4)). If packet 1210C were permitted to be written to slot 0 before packet 1210B has been consumed by destination unit 1200, packet 1210B would be overwritten and lost. The sliding transmission window mechanism described above with respect to FIGS. 7 through 11 may prevent this aliasing condition by withholding source units from transmitting packets whose sequence identifiers fall outside the current transmission window. In the example shown, if the current transmission window includes effective sequence values 4 through 7, the source unit responsible for packet 1210C (Y=8) may be withheld from transmitting until the window advances past 8. In some implementations, input buffer 1202 may be a circular buffer, and the modular reduction of the sequence identifier by the buffer depth may serve as the index into the circular buffer. In other implementations, input buffer 1202 may be a direct-mapped structure in which the transmitted sequence identifier or a portion thereof may serve directly as a write address. In still other implementations, input buffer 1202 may comprise a multi-bank buffer in which one field of the sequence identifier selects a bank and another field selects an entry within the bank. While input buffer 1202 is shown with a depth of 4, implementations are not so limited. In some implementations, the depth of input buffer 1202 may be 8, 16, 32, 64, 128, or any other depth suitable for the dataflow operation being executed. The depth of input buffer 1202 may be configurable. Destination unit 1200 may read packets from input buffer 1202 in order of the sequence identifiers, beginning at a read pointer that may indicate the next buffer entry to be consumed. Once destination unit 1200 has consumed one or more consecutive packets, the valid indicators for those consumed entries may be cleared, making the buffer entries available for reuse. Additional details regarding the consumption of packets from the input buffer and the transmission of credits to source units are provided below with respect to FIGS. 13A and 13B. FIG. 13A illustrates a block diagram of an example destination unit 1300 and a plurality of source units 1322A-1322E showing an input buffer 1302 before consumption of packets, in accordance with example embodiments of the disclosure. FIG. 13A may illustrate the state of destination unit 1300 and source units 1322A-1322E at a point in time after packets have been received and stored in input buffer 1302 but before destination unit 1300 has consumed those packets and transmitted a credit to the source units. Destination unit 1300 may correspond to destination unit 1200 of FIG. 12, to destination unit 704 of FIGS. 7 through 11, or to destination CGRU 538 of FIG. 5. As illustrated, destination unit 1300 may include an input interface 1330, an input buffer 1302, a read pointer 1316, a data output 1336, and a credit output interface 1318. Input interface 1330 may receive packets from the interconnect network and may route the received packets to input buffer 1302 for storage at locations addressed by the transmitted sequence identifiers carried in the packets, as described above with respect to FIG. 12. Input buffer 1302 may include a plurality of buffer entries, each entry including a data field and a valid indicator. As illustrated, input buffer 1302 may include buffer entries 1304A, 1304B, 1304C, and 1304D corresponding to buffer slots 0, 1, 2, and 3, respectively. Each buffer entry may have a respective valid indicator 1306A, 1306B, 1306C, and 1306D, and a respective data field 1308A, 1308B, 1308C, and 1308D. In the state shown in FIG. 13A, all four buffer entries may be occupied with valid packets. Buffer entry 1304A (slot 0) may contain packet 1210B (Y=4) and valid indicator 1306A may be set to 1. Buffer entry 1304B (slot 1) may contain packet 1210D (Y=5) and valid indicator 1306B may be set to 1. Buffer entry 1304C (slot 2) may contain packet 1210E (Y=6) and valid indicator 1306C may be set to 1. Buffer entry 1304D (slot 3) may contain packet 1210A (Y=7) and valid indicator 1306D may be set to 1. Read pointer 1316 may indicate the next buffer entry to be consumed by destination unit 1300. In the state shown in FIG. 13A, read pointer 1316 may point to buffer entry 1304A (slot 0), indicating that destination unit 1300 may consume the packet at slot 0 first. Data output 1336 may provide an output path by which consumed packets may be delivered to downstream processing logic within or coupled to destination unit 1300. Credit output interface 1318 may provide an output path by which destination unit 1300 may transmit a credit message to source units via a scalar network 1320. In the state shown in FIG. 13A, no packets may have been consumed and no credit may have been transmitted. Scalar network 1320 may couple destination unit 1300 to source units 1322A, 1322B, 1322C, 1322D, and 1322E (labeled Src 0, Src 1, Src 2, Src 3, and Src 4, respectively). Scalar network 1320 may correspond to a scalar bus of the array-level network described above with reference to FIG. 4. In some implementations, scalar network 1320 may support multicast transmission, such that a single credit message transmitted by destination unit 1300 may be received simultaneously by all source units 1322A-1322E. Each source unit 1322A-1322E may maintain a respective transmission window 1324A, 1324B, 1324C, 1324D, and 1324E, and a respective base offset counter 1326A, 1326B, 1326C, 1326D, and 1326E. Source units 1322A-1322E may correspond to source units 702A-702E of FIGS. 7 through 11. In the state shown in FIG. 13A, each source unit 1322A-1322E may maintain a transmission window of [0, 4) and a base offset counter value of B=0. The transmission windows may be coherent across all source units, such that each source unit maintains the same range of valid sequence identifiers at any given time. The base offset counter value of B=0 may indicate that the source units are operating in a first iteration of a dataflow operation. FIG. 13B illustrates a block diagram of destination unit 1300 and source units 1322A-1322E of FIG. 13A showing input buffer 1302 after consumption of packets and transmission of a credit message, in accordance with example embodiments of the disclosure. FIG. 13B may illustrate the state of destination unit 1300 and source units 1322A-1322E at a point in time after destination unit 1300 has consumed a quantity of consecutive packets from input buffer 1302 and has transmitted a credit message 1328 to the source units via scalar network 1320. In the state shown in FIG. 13B, destination unit 1300 may have consumed three consecutive packets from input buffer 1302: the packets previously stored at buffer entries 1304A (slot 0), 1304B (slot 1), and 1304C (slot 2), corresponding to packets with effective sequence values Y=4, Y=5, and Y=6, respectively. The consumed packets 1338 may have been delivered to downstream processing logic via data output 1336. Upon consumption of each packet, destination unit 1300 may have cleared the respective valid indicators. As illustrated, valid indicators 1306A, 1306B, and 1306C for slots 0, 1, and 2 may now be set to 0, indicating that those buffer entries are empty and available for reuse. Buffer entry 1304D (slot 3) may still contain packet 1210A (Y=7), and valid indicator 1306D may remain set to 1, indicating that the packet at slot 3 has not yet been consumed. Read pointer 1316 may have been advanced from slot 0 to slot 3, reflecting the consumption of the three packets at slots 0, 1, and 2. Read pointer 1316 may now indicate that the next packet to be consumed is the packet at buffer entry 1304D (slot 3). Upon consuming the three consecutive packets, destination unit 1300 may have transmitted a credit message 1328 via credit output interface 1318 onto scalar network 1320. Credit message 1328 may indicate the quantity of packets consumed by destination unit 1300, or the source units may be preconfigured to know the consumption quantum. Credit message 1328 may be transmitted as a multicast message on scalar network 1320, such that a single credit message may cause all source units 1322A-1322E to receive the credit simultaneously. In response to receiving credit message 1328, each source unit 1322A-1322E may have advanced its respective transmission window. As illustrated, transmission windows 1324A, 1324B, 1324C, 1324D, and 1324E may have advanced from [0, 4) (as shown in FIG. 13A) to [3, 7). Advancing the transmission window may comprise incrementing the lower bound and the upper bound of the range by the quantity of packets consumed. In this example, three packets may have been consumed, so the lower bound may have advanced from 0 to 3 and the upper bound may have advanced from 4 to 7. The base offset counters 1326A-1326E may remain at B=0, because the source units may still be operating within the first iteration of the dataflow operation. The base offset counters may be incremented at the end of an iteration, as discussed further below with respect to FIG. 14. The advanced transmission windows [3, 7) may now include effective sequence values that were previously outside the valid range. Source units that were previously withheld from transmitting because their effective sequence values fell outside the range [0, 4) may now be permitted to transmit if their effective sequence values fall within the range [3, 7). The freed buffer entries at slots 0, 1, and 2 may now be available to receive new packets whose transmitted sequence identifiers map to those slots. For example, a packet with an effective sequence value of Y=8 may have a transmitted sequence identifier of 8 MOD 4=0, and may be written to buffer entry 1304A (slot 0), which was freed when the previous occupant was consumed. The cycle of receiving packets, consuming packets in sequence identifier order, transmitting credits, and advancing transmission windows may repeat throughout the execution of the dataflow operation. Each credit cycle may free one or more buffer entries at destination unit 1300 and may permit additional source units to transmit. Because credit message 1328 may be multicast to all source units simultaneously, a single credit transmission may advance all source transmission windows by the same quantity, maintaining coherence across the source units. Additional details regarding the internal structure of the source units, including the computation of effective sequence values and the comparison against the transmission window, are provided below with respect to FIG. 14. FIG. 14 illustrates a block diagram of an example source unit 1400 including a base offset counter, a per-packet offset, an adder, a comparator, a modulo unit, and a transmission window, in accordance with example embodiments of the disclosure. Source unit 1400 may correspond to any one of source units 1322A-1322E of FIGS. 13A and 13B, to any one of source units 702A-702E of FIGS. 7 through 11, or to source CGRUs 503 and 504 of FIG. 5. FIG. 14 may illustrate the internal computation pipeline by which source unit 1400 may determine a transmitted sequence identifier for each packet and may evaluate whether the packet is permitted to be transmitted under the current transmission window. As illustrated, source unit 1400 may include a base offset counter 1402, a per-packet offset 1404, an adder 1406, a transmission window 1410, a comparator 1416, a modulo unit 1418, a credit input 1424, and an output interface 1426. Base offset counter 1402 may store a base value that may accumulate across successive iterations of a dataflow operation. At the beginning of a first iteration, base offset counter 1402 may be initialized to zero. At the end of each iteration, base offset counter 1402 may be incremented by a value corresponding to the aggregate number of packets generated across all source units in a many-to-one group during that iteration. For example, if five source units each transmit ten packets per iteration, base offset counter 1402 may be incremented by 50 at the end of each iteration. Base offset counter 1402 may provide a base signal 1432 to adder 1406. In some implementations, base offset counter 1402 may have a bit width that is greater than the bit width of the transmitted sequence identifier carried in the packet header, enabling the system to operate across a large number of iterations before the counter approaches a wraparound boundary. In some implementations, base offset counter 1402 may correspond to base offset counters 1326A-1326E of FIGS. 13A and 13B. Per-packet offset 1404 may store an offset value that may be assigned at configuration time, such as by a compiler, and may remain unchanged across successive iterations of the dataflow operation. Per-packet offset 1404 may identify the position of the current packet within the sequence of packets produced by all source units in the many-to-one group. For example, in a group of four source units where each source unit transmits one packet per iteration, source unit 0 may have a per-packet offset of 0, source unit 1 may have a per-packet offset of 1, source unit 2 may have a per-packet offset of 2, and source unit 3 may have a per-packet offset of 3. In some implementations where a source unit transmits multiple packets per iteration, per-packet offset 1404 may comprise a set of offset values, and the source unit may select an offset from the set for each successive packet. Per-packet offset 1404 may provide an offset signal 1434 to adder 1406. Adder 1406 may compute a sum of base signal 1432 and offset signal 1434 to produce a sum signal 1436. Sum signal 1436 may represent the effective sequence value for the current packet. The effective sequence value may be the result of adding the base offset counter value to the per-packet offset value, and may uniquely identify the position of the current packet within the global ordering across all iterations and all source units. Because base offset counter 1402 may be incremented by the aggregate packet count at the end of each iteration, the effective sequence values for packets in successive iterations may be distinct even though the per-packet offsets may be the same, enabling the same input buffer locations to be reused across iterations without aliasing. Sum signal 1436 may be provided to both comparator 1416 and modulo unit 1418. In some implementations, sum signal 1436 may fork into two parallel paths: one path leading to comparator 1416 for window comparison, and another path leading to modulo unit 1418 for computation of the transmitted sequence identifier. Transmission window 1410 may define the range of effective sequence values for which source unit 1400 is permitted to transmit packets. Transmission window 1410 may include a lower bound X1 1412 and an upper bound X2 1414. In some implementations, the range defined by transmission window 1410 may be [X1, X2), representing all effective sequence values Y such that X1 is less than or equal to Y and Y is less than X2. Transmission window 1410 may provide a window signal [X1, X2] 1438 to comparator 1416. Transmission window 1410 may correspond to transmission windows 1324A-1324E of FIGS. 13A and 13B. In some implementations, the difference between upper bound X2 1414 and lower bound X1 1412 may equal the depth of the input buffer at the destination unit, such that the set of effective sequence values currently valid for transmission may correspond to the set of buffer locations available for writing. Comparator 1416 may receive sum signal 1436 and window signal [X1, X2] 1438, and may produce a result signal 1444 indicating whether the effective sequence value represented by sum signal 1436 falls within the range defined by transmission window 1410. In some implementations, comparator 1416 may evaluate the condition X1<=Y<X2, where Y is the effective sequence value. If the condition is satisfied, result signal 1444 may indicate that the packet is within the transmission window and may be transmitted. If the condition is not satisfied, result signal 1444 may indicate that the packet is outside the transmission window and should be withheld from transmission. In some implementations, result signal 1444 may serve as an enable signal for modulo unit 1418 and/or output interface 1426, such that the modulo computation and packet transmission may proceed when the effective sequence value is within the transmission window. Modulo unit 1418 may receive sum signal 1436 and may compute a transmitted sequence identifier (TX SEQ ID) 1442 by performing a modular reduction of the effective sequence value by the depth of the input buffer at the destination unit. TX SEQ ID 1442 may be the value placed in the packet header for transmission over the interconnect network and may serve as the write address at the destination unit's input buffer, as described above with respect to FIG. 12. In some implementations, modulo unit 1418 may be enabled by result signal 1444 from comparator 1416, such that TX SEQ ID 1442 is produced when the effective sequence value is within the transmission window. In other implementations, modulo unit 1418 may compute TX SEQ ID 1442 unconditionally, and result signal 1444 may gate the output interface 1426 to prevent transmission of the packet when the effective sequence value is outside the window. Output interface 1426 may receive TX SEQ ID 1442 from modulo unit 1418 and may transmit a packet 1422 to the interconnect network. Packet 1422 may include the TX SEQ ID 1442 in its header and may include data payload produced by the source unit or by an upstream configurable unit. Output interface 1426 may correspond to a vector or scalar interface on the source unit's connection to a switch unit, such as switch units 403 of FIG. 4. Credit input 1424 may receive a credit signal 1440 from scalar network 1320. Credit signal 1440 may correspond to credit message 1328 of FIG. 13B. In response to receiving credit signal 1440, source unit 1400 may update transmission window 1410 by advancing lower bound X1 1412 and upper bound X2 1414 by the quantity of packets consumed at the destination unit, as illustrated in FIG. 13B. Credit input 1424 may be coupled to scalar network 1320, which may be a scalar bus of the array-level network described above with reference to FIG. 4. In some implementations, the effective sequence value represented by sum signal 1436, base offset counter 1402, and the bounds of transmission window 1410 (X1 1412 and X2 1414) may each have a bit width greater than the bit width of TX SEQ ID 1442 carried in the packet header. The wider internal representation may enable the system to distinguish between packets from different iterations even when their modular reductions to transmitted sequence identifiers are identical. For example, a packet with effective sequence value Y=4 in iteration 0 and a packet with effective sequence value Y=54 in iteration 1 may both produce a TX SEQ ID of 4 MOD DEPTH, but the wider effective sequence values may be distinct and may map to different positions in the transmission window. This two-space architecture, which may have wider effective values for internal comparison and narrower transmitted identifiers for the packet header and buffer addressing, may enable the system to reuse the same set of buffer locations across iterations without aliasing, because the wider effective sequence values for different iterations may be distinct even when their modular reductions may be the same. In some implementations, the number of iterations supportable between synchronization events may scale with 2 raised to the power of the difference between the wider bit width (of base offset counter 1402 and transmission window 1410) and the narrower bit width (of TX SEQ ID 1442). In some implementations, the wider bit width may be chosen to be large enough that wraparound does not occur within the expected operational lifetime of a single configuration. In other implementations, the system may perform a synchronization event to reset base offset counter 1402 and transmission window 1410 when the effective sequence value approaches a wraparound boundary. Additional details regarding the method by which source unit 1400 may compute effective sequence values, compare against the transmission window, and transmit packets are provided below with respect to FIG. 15. Additional details regarding the method by which a destination unit may receive packets, store them in the input buffer, consume them in sequence identifier order, and transmit credits are provided below with respect to FIG. 16. FIG. 15 illustrates a flow diagram of an example method 1500 of transmitting packets from a source unit including computing an effective sequence value and comparing against a transmission window, in accordance with example embodiments of the disclosure. Method 1500 may be performed by source unit 1400 of FIG. 14, by any one of source units 1322A-1322E of FIGS. 13A and 13B, or by any one of source units 702A-702E of FIGS. 7 through 11. In some implementations, method 1500 may be performed by a source CGRU such as CGRU 503 or 504 of FIG. 5. Method 1500 may be repeated for each packet that the source unit is configured to transmit to a destination unit during execution of a dataflow operation. At block 1502, the source unit may receive configuration data. The configuration data may be provided by a host processor, such as host 180 of FIG. 1, and may be loaded into a configuration store of the source unit, such as Cfg 402 of FIG. 4. The configuration data may include a set of per-packet sequence identifier offsets assigned at compile time, initial values for the transmission window (e.g., lower bound X1 and upper bound X2), an initial value for the base offset counter (e.g., zero), and parameters identifying the destination unit and the depth of the destination unit's input buffer. In some implementations, the configuration data may be compiled by compiler 182 of FIG. 1 and loaded via a configuration load process as described above with reference to FIG. 4. At block 1504, the source unit may select a per-packet offset from the configured set of offsets. The per-packet offset may identify the position of the current packet within the sequence of packets produced by all source units in the many-to-one group. The per-packet offset may correspond to per-packet offset 1404 of FIG. 14. In some implementations, the source unit may transmit multiple packets per iteration, and may select a different offset from the configured set for each successive packet. In other implementations, the source unit may transmit a single packet per iteration and may have a single per-packet offset. At block 1506, the source unit may compute an effective sequence value for the current packet. Computing the effective sequence value may comprise adding the current value of the base offset counter to the selected per-packet offset. The base offset counter may correspond to base offset counter 1402 of FIG. 14, and the addition may be performed by adder 1406 of FIG. 14. The resulting effective sequence value may correspond to sum signal 1436 of FIG. 14. The effective sequence value may uniquely identify the position of the current packet within the global ordering across all iterations and all source units. At block 1508, the source unit may compare the effective sequence value against the transmission window. The comparison may determine whether the effective sequence value falls within the range defined by the transmission window, such as evaluating the condition X1<=Y<X2, where Y is the effective sequence value and X1 and X2 are the lower and upper bounds of the transmission window. The comparison may be performed by comparator 1416 of FIG. 14, using sum signal 1436 and window signal [X1, X2] 1438. If the effective sequence value is within the transmission window (YES), method 1500 may proceed to block 1510. If the effective sequence value is outside the transmission window (NO), method 1500 may proceed to block 1512. At block 1510, in response to the effective sequence value being within the transmission window, the source unit may compute a modulo of the effective sequence value by the depth of the destination unit's input buffer to produce a transmitted sequence identifier. The modulo computation may be performed by modulo unit 1418 of FIG. 14, and the transmitted sequence identifier may correspond to TX SEQ ID 1442 of FIG. 14. The transmitted sequence identifier may be placed in the header of the packet for transmission over the interconnect network, and may serve as the write address at the destination unit's input buffer, as described above with respect to FIG. 12. At block 1514, the source unit may transmit the packet including the transmitted sequence identifier to the destination unit via the interconnect network. The transmission may be performed via output interface 1426 of FIG. 14. The packet may traverse one or more switches of the array-level network, such as switches 403 of FIG. 4, to reach the destination unit. At block 1516, the source unit may optionally increment a local sequence counter. In some implementations, the local sequence counter may track the number of packets that the source unit has transmitted during the current iteration. At block 1515, the source unit may determine whether there are more packets to transmit in the current iteration. If there are more packets (YES), method 1500 may return to block 1504 to select the per-packet offset for the next packet. If there are no more packets in the current iteration (NO), method 1500 may proceed to block 1520. At block 1520, the source unit may update the base offset counter. Updating the base offset counter may comprise incrementing the base offset counter by a value corresponding to the aggregate number of packets generated across all source units in the many-to-one group during the current iteration. For example, if five source units each transmit ten packets per iteration, the base offset counter may be incremented by 50. The updated base offset counter value may cause the effective sequence values for packets in the next iteration to be distinct from the effective sequence values of the current iteration, enabling the same input buffer locations at the destination to be reused across iterations without aliasing. After updating the base offset counter, method 1500 may return to block 1504 to begin transmitting packets for the next iteration. At block 1512, in response to the effective sequence value being outside the transmission window, the source unit may withhold the packet from transmission. Withholding the packet may comprise preventing the packet from being transmitted to the destination unit until the transmission window advances to include the effective sequence value. The source unit may wait for a credit from the destination unit before re-evaluating the comparison. At block 1522, the source unit may receive a credit from the destination unit. The credit may arrive via credit input 1424 of FIG. 14 from scalar network 1320, and may correspond to credit message 1328 of FIG. 13B. The credit may indicate that the destination unit has consumed a quantity of consecutive packets and that corresponding input buffer locations are now available for reuse. At block 1524, in response to receiving the credit, the source unit may update the transmission window. Updating the transmission window may comprise advancing the lower bound X1 and the upper bound X2 by the quantity of packets consumed, as described above with respect to FIG. 13B. After updating the transmission window, method 1500 may return to block 1508 to re-evaluate whether the effective sequence value of the withheld packet now falls within the updated transmission window. If the effective sequence value now falls within the window, method 1500 may proceed through blocks 1510 and 1514 to compute the modulo and transmit the previously withheld packet. In some implementations, blocks 1522 and 1524 may execute asynchronously with respect to the transmission path. For example, the source unit may receive and process credits at any time, not only when a packet is being withheld. In such implementations, the transmission window may be updated in the background, and a withheld packet may become eligible for transmission as soon as the window advances sufficiently, without an explicit re-evaluation step. Method 1500 is illustrated as a sequence of blocks for clarity of description. However, the operations described in method 1500 may be performed in different orders, may be combined or separated, and may be performed concurrently or in pipeline fashion. Method 1500 may include more or fewer operations than shown. Any of the operations described may be performed by hardware, software, firmware, or any combination thereof. In some implementations, method 1500 may be embodied in configuration data stored on a non-transitory computer-readable medium, such as CRM 235 of FIG. 2, that when loaded into a reconfigurable data processor may configure the processor to perform the operations of method 1500. FIG. 16 illustrates a flow diagram of an example method 1600 of receiving and consuming packets at a destination unit including transmitting a credit to a plurality of source units, in accordance with example embodiments of the disclosure. Method 1600 may be performed by destination unit 1300 of FIGS. 13A and 13B, by destination unit 1200 of FIG. 12, or by destination unit 704 of FIGS. 7 through 11. In some implementations, method 1600 may be performed by a destination CGRU such as CGRU 538 of FIG. 5. Method 1600 may be repeated for each packet received at the destination unit during execution of a dataflow operation. At block 1602, the destination unit may receive a packet from one of a plurality of source units via the interconnect network. The packet may arrive at an input interface of the destination unit, such as input interface 1330 of FIG. 13A, via one or more switches of the array-level network, such as switches 403 of FIG. 4. The packet may include a transmitted sequence identifier in its header and a data payload. At block 1604, the destination unit may extract the transmitted sequence identifier from the header of the received packet. The transmitted sequence identifier may correspond to TX SEQ ID 1442 as computed by the source unit in FIG. 14 and placed in the packet header at block 1510 of method 1500 of FIG. 15. In some implementations, the transmitted sequence identifier may have been derived by the source unit as a modular reduction of an effective sequence value by the depth of the destination unit's input buffer. At block 1606, the destination unit may store the packet at a location in the input buffer addressed by the transmitted sequence identifier. The input buffer may correspond to input buffer 1202 of FIG. 12 or input buffer 1302 of FIGS. 13A and 13B. In some implementations, the transmitted sequence identifier may serve directly as the write address for the input buffer. In other implementations, the destination unit may compute a write address from the transmitted sequence identifier, such as by performing a modular reduction by the buffer depth, as described above with respect to write address computation 1220 of FIG. 12. The packet may be stored at the buffer entry addressed by the write address, regardless of the order in which the packet arrived relative to packets from other source units. At block 1608, the destination unit may set a valid indicator for the buffer entry at which the packet was stored. The valid indicator may correspond to valid indicators 1206A-1206D of FIG. 12 or 1306A-1306D of FIG. 13A. Setting the valid indicator may indicate that a valid packet has been received and stored at that buffer location, and that the location is ready for consumption. At block 1610, the destination unit may determine whether a consumption condition is satisfied. In some implementations, the consumption condition may be satisfied when a predetermined quantity of consecutive buffer entries, starting at a read pointer such as read pointer 1316 of FIG. 13A, each have their valid indicators set, indicating that the corresponding packets have been received and are available for consumption. The predetermined quantity may correspond to a dequeue granularity that may be configured at configuration time. If the consumption condition is satisfied (YES), method 1600 may proceed to block 1612. If the consumption condition is not satisfied (NO), method 1600 may return to block 1602 to receive the next packet. In some implementations, the destination unit may evaluate the consumption condition each time a valid indicator is set. In other implementations, the destination unit may evaluate the consumption condition periodically or in response to other triggers. At block 1612, the destination unit may consume the packets. Consuming the packets may comprise reading the predetermined quantity of consecutive packets from the input buffer in sequence identifier order, beginning at the read pointer. The consumed packets may be delivered to downstream processing logic within or coupled to the destination unit via a data output, such as data output 1336 of FIG. 13A. In some implementations, consuming the packets may comprise providing the packet data to a compute pipeline, to a memory store such as MS 613 of FIG. 6, or to another CGRU via the interconnect network. At block 1614, the destination unit may advance the read pointer. Advancing the read pointer may comprise incrementing the read pointer by the quantity of packets consumed, such that the read pointer now indicates the next unconsumed buffer entry. In the example of FIG. 13B, the read pointer may have advanced from slot 0 to slot 3 after consuming three consecutive packets. At block 1616, the destination unit may clear the valid indicators for the buffer entries from which packets were consumed. Clearing the valid indicators may indicate that those buffer entries are now empty and available for reuse by newly arriving packets. In the example of FIG. 13B, valid indicators 1306A, 1306B, and 1306C for slots 0, 1, and 2 may have been cleared after the packets at those slots were consumed. At block 1618, the destination unit may transmit a credit to each of the plurality of source units. The credit may be transmitted via a credit output interface, such as credit output interface 1318 of FIG. 13A, onto a scalar network, such as scalar network 1320 of FIGS. 13A and 13B. In some implementations, the credit may be transmitted as a multicast message, such as credit message 1328 of FIG. 13B, such that a single credit transmission may cause all source units communicating with the destination unit to receive the credit simultaneously. The credit may indicate the quantity of packets consumed, or the source units may be preconfigured with the consumption quantum. In response to receiving the credit, each source unit may advance its transmission window, as described above with respect to block 1524 of method 1500 of FIG. 15 and as illustrated in FIG. 13B. After transmitting the credit, method 1600 may return to block 1602 to continue receiving packets. In some implementations, blocks 1602 through 1608 and blocks 1610 through 1618 may operate concurrently or in a pipelined fashion. For example, the destination unit may continue to receive and store packets (blocks 1602-1608) while simultaneously consuming previously stored packets and transmitting credits (blocks 1612-1618). In some implementations, the consumption and credit transmission may occur in the background relative to the packet reception path, such that the destination unit does not stall its receive interface while consuming packets and transmitting credits. Method 1600 is illustrated as a sequence of blocks for clarity of description. However, the operations described in method 1600 may be performed in different orders, may be combined or separated, and may be performed concurrently or in pipeline fashion. Method 1600 may include more or fewer operations than shown. Any of the operations described may be performed by hardware, software, firmware, or any combination thereof. In some implementations, method 1600 may be embodied in configuration data stored on a non-transitory computer-readable medium, such as CRM 235 of FIG. 2, that when loaded into a reconfigurable data processor may configure the processor to perform the operations of method 1600.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The illustrated aspects of the claimed subject matter may also be practiced in distributed computing environments where certain tasks are performed by remote processing devices that are linked through a communications network. In a distributed computing environment, program modules may be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example implementations of the disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some implementations of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that may direct a computer or other programmable data processing apparatus to function in a particular manner, such that the instructions stored in the computer-readable memory produce an article of manufacture including instruction that implement one or more functions specified in the flow diagram block or blocks. As an example, implementations of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases may be in communication with each other and/or other databases, such as a centralized database, or other types of data storage devices. When needed, data or information stored in a memory or database may be transmitted to a centralized database capable of receiving data, information, or data records from more than one database or other data storage devices. In other implementations, the databases shown may be integrated or distributed into any number of databases or other data storage devices.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

### EXAMPLE CLAUSES

Clause 1. A system comprising: an array of configurable units coupled by an interconnect network, the array of configurable units including a plurality of source units and a destination unit; wherein the plurality of source units are configured to transmit packets to the destination unit, a first packet of the packets including a first sequence identifier and a second packet of the packets including a second sequence identifier; and wherein the destination unit is configured to consume at least the first packet and the second packet in an order determined by the first sequence identifier and the second sequence identifier regardless of an order in which the first packet and the second packet are received from the plurality of source units.

Clause 2. The system of clause 1, wherein the destination unit comprises an input buffer configured to store a received packet at a location in the input buffer addressed by a sequence identifier included in the received packet.

Clause 3. The system of any one of clauses 2 or 9, wherein a write address for the input buffer is determined as a modulo of the sequence identifier and a depth of the input buffer.

Clause 4. The system of any one of clauses 2 or 3, wherein the sequence identifier comprises a source number component identifying a source unit of the plurality of source units and a sequence number component.

Clause 5. The system of clause 4, wherein a number of bits allocated to the source number component and a number of bits allocated to the sequence number component are configurable by a compiler.

Clause 6. The system of clause 4, wherein a compiler assigns a unique source number to a source unit of the plurality of source units.

Clause 7. The system of any one of clauses 2, 3, or 9, wherein the destination unit maintains a valid bit per location of the input buffer indicating whether a packet has been received for the location.

Clause 8. The system of clause 7, wherein the destination unit maintains a read pointer, and wherein the destination unit reads a packet from the input buffer when a valid bit corresponding to the read pointer indicates that the packet has been received.

Clause 9. The system of any one of clauses 2, 3, or 7, wherein the destination unit is configured to read packets stored in the input buffer in an order determined by sequence identifiers included in the packets.

Clause 10. The system of any one of clauses 2, 3, 7, or 9, wherein one or more source units of the plurality of source units maintain respective transmission windows defining a range of sequence identifiers and are configured to transmit a packet when a sequence identifier of the packet is within a respective transmission window, wherein the destination unit is configured to transmit a credit to the one or more source units upon consuming a quantity of the packets in an order determined by sequence identifiers included in the packets, and wherein the one or more source units are configured to advance the respective transmission windows in response to receiving the credit and include respective base offset counters configured to accumulate an aggregate number of packets generated across the plurality of source units per iteration of a data processing operation.

Clause 11. The system of clause 10, wherein a source unit of the one or more source units computes an effective sequence value in a numerical space having a greater bit width than a transmitted sequence identifier included in a packet.

Clause 12. The system of clause 11, wherein the respective transmission window is defined in the numerical space of the effective sequence value, and wherein determining whether a packet is permitted to transmit comprises comparing the effective sequence value to a minimum value and a maximum value of the respective transmission window.

Clause 13. The system of clause 12, wherein the transmitted sequence identifier included in the packet is a modulo-reduced value derived from the effective sequence value, and wherein the destination unit uses the modulo-reduced value as a write address for the input buffer.

Clause 14. The system of clause 13, wherein the destination unit consumes packets in an order corresponding to an increasing order of effective sequence values represented within a current transmission window while buffer locations are reused circularly.

Clause 15. The system of clause 10, wherein the respective transmission windows are constrained such that packets transmitted by the one or more source units do not overwrite buffer locations corresponding to unconsumed packets at the destination unit when transmitted sequence identifiers wrap around modulo a depth of the input buffer.

Clause 16. The system of any one of clauses 2, 3, or 9, wherein the input buffer comprises a circular buffer.

Clause 17. The system of any one of clauses 2, 3, or 9, wherein the input buffer comprises a first-in first-out buffer repurposed as a reorder buffer by addressing write locations using the sequence identifier.

Clause 18. The system of any one of clauses 2, 3, 7, or 9, wherein the destination unit maintains a read pointer initialized to zero.

Clause 19. The system of any one of clauses 8 or 18, wherein the destination unit reads a quantity of packets starting from the read pointer when valid bits for the quantity of consecutive locations starting at the read pointer are set, and transmits a credit upon completing the read.

Clause 20. The system of clause 19, wherein the destination unit advances the read pointer by a quantity of packets read.

Clause 21. The system of clause 19, wherein the destination unit withholds transmission of the credit until valid bits for a configurable dequeue quantity of consecutive locations starting at the read pointer are all set.

Clause 22. The system of any one of clauses 1 or 2, wherein the packets comprise vector data packets carried on a vector bus of the interconnect network.

Clause 23. The system of any one of clauses 1 or 2, wherein a packet of the packets includes a header comprising a destination identifier identifying geographical coordinates of a destination switch unit and an interface identifier identifying an interface on the destination switch unit.

Clause 24. The system of any one of clauses 1 or 2, wherein the interconnect network comprises a vector network, a scalar network, and a control network.

Clause 25. The system of any one of clauses 1 or 2, wherein one or more source units of the plurality of source units maintain respective transmission windows defining a range of sequence identifiers, and wherein the one or more source units are configured to transmit a packet to the destination unit when a sequence identifier of the packet is within a respective transmission window.

Clause 26. The system of clause 25, wherein the destination unit is configured to, upon consuming a quantity of packets in an order determined by sequence identifiers included in the packets, transmit a credit to the one or more source units, and wherein the one or more source units are configured to advance the respective transmission windows in response to receiving the credit.

Clause 27. The system of clause 26, wherein a source unit of the one or more source units is configured to withhold transmission of a packet when a sequence identifier of the packet is outside the respective transmission window of the source unit.

Clause 28. The system of clause 26, wherein the respective transmission windows have a minimum value initialized to zero and a maximum value initialized to a size of the input buffer at the destination unit.

Clause 29. The system of clause 26, wherein the quantity of packets consumed before transmitting the credit is a configurable dequeue quantity.

Clause 30. The system of clause 26, wherein the credit is transmitted on a scalar bus of the interconnect network, and wherein a payload of the credit indicates credit units returned.

Clause 31. The system of clause 26, wherein the credit is transmitted as a multicast from the destination unit to the one or more source units using a single transmission.

Clause 32. The system of clause 26, wherein the destination unit transmits the credit via a scalar network, and wherein the scalar network supports multicast by routing a single scalar packet to multiple destination switch interfaces using a flow table.

Clause 33. The system of clause 26, wherein a source unit of the one or more source units is programmed to send a number of packets per iteration defining an interleaving factor, and wherein the respective transmission windows constrain transmission when the interleaving factor exceeds a size of a reorder buffer at the destination unit.

Clause 34. The system of clause 33, wherein the interleaving factor is less than a size of the reorder buffer, and wherein a first source unit of the one or more source units transmits packets without waiting for credits while a second source unit waits for credits before transmitting.

Clause 35. The system of clause 26, wherein a source unit of the one or more source units produces a quantity Y by adding a per-packet sequence identifier offset to a base offset counter value, wherein the source unit compares Y against a minimum value X1 and a maximum value X2 of the respective transmission window, and wherein, upon determining that X1 is less than or equal to Y and Y is less than X2, the source unit readies the packet for transmission and includes in the packet a transmitted sequence identifier derived from Y by a modulo operation with respect to a reorder buffer size.

Clause 36. The system of clause 35, wherein Y has a higher bit-width than a transmitted sequence identifier included in a packet, and wherein the transmitted sequence identifier is determined as Y modulo a depth of an input buffer at the destination unit.

Clause 37. The system of clause 36, wherein X1 and X2 have a same bit-width as Y, such that a comparison of Y against X1 and X2 is performed in a numerical space wider than the transmitted sequence identifier, and wherein the transmitted sequence identifier derived by modular reduction indexes a location in the input buffer.

Clause 38. The system of clause 26, wherein, when sequence identifiers wrap around from a maximum sequence identifier value back to zero, a source unit of the one or more source units withholds transmission until the destination unit has consumed packets occupying aliased locations in the input buffer and the respective transmission windows have been advanced to include the wrapped-around sequence identifiers.

Clause 39. The system of clause 26, wherein the respective transmission windows at the one or more source units are coherent, such that the one or more source units maintain a same range of sequence identifiers.

Clause 40. The system of clause 39, wherein the coherent respective transmission windows are maintained by the one or more source units receiving and applying a same credit from the destination unit.

Clause 41. The system of any one of clauses 1 or 2, wherein one or more source units of the plurality of source units include respective base offset counters associated with the destination unit, the respective base offset counters configured to accumulate an aggregate number of packets generated across the plurality of source units per iteration.

Clause 42. The system of clause 41, wherein, at an end of an iteration, a value corresponding to the aggregate number of packets generated across the plurality of source units in the iteration is added to a respective base offset counter.

Clause 43. The system of clause 41, wherein a sequence identifier for a packet produced by a source unit of the one or more source units is determined by adding a per-packet sequence identifier offset to a value of the respective base offset counter.

Clause 44. The system of clause 43, wherein the per-packet sequence identifier offset for a source unit of the one or more source units is configured at a configuration time and remains unchanged across successive iterations of a data processing operation.

Clause 45. The system of clause 44, wherein a respective base offset counter shifts the per-packet sequence identifier offset into a different range of effective sequence values in each successive iteration, such that the input buffer is reused across the successive iterations without reconfiguring the per-packet sequence identifier offset.

Clause 46. The system of clause 43, wherein the per-packet sequence identifier offset is assigned by a compiler based on a position of a source unit in a dataflow graph mapped onto the array of configurable units.

Clause 47. The system of clause 41, wherein an iteration comprises a completion of production of output vectors from a granule of compute or a read of a fraction of a tensor.

Clause 48. The system of clause 41, wherein the one or more source units and the destination unit are configured to perform a synchronization event to reset the respective base offset counters and respective transmission windows maintained at the one or more source units responsive to a respective base offset counter approaching a wraparound boundary.

Clause 49. The system of clause 48, wherein the synchronization event comprises a barrier synchronization across the one or more source units and the destination unit.

Clause 50. The system of clause 41, wherein the respective base offset counters and respective transmission windows maintained at the one or more source units have a higher bit-width than a sequence identifier included in a packet, and wherein a number of iterations that can be executed between synchronization events to reset the respective base offset counters is determined by a difference between a bit-width of the respective base offset counters and a bit-width of a transmitted sequence identifier.

Clause 51. The system of any one of clauses 1 or 2, wherein a source unit of the plurality of source units includes configuration values specifying a number of packets the source unit is programmed to send to the destination unit per iteration.

Clause 52. The system of any one of clauses 1 or 2, wherein a source unit of the plurality of source units includes a sequence identifier counter, and wherein the sequence identifier counter is cleared upon completion of a context.

Clause 53. The system of clause 52, wherein the sequence identifier counter generates a sequence number modulo a configured maximum value.

Clause 54. The system of clause 52, wherein, at an end of an iteration that is not a final iteration of a context, a base offset counter at the source unit is incremented by an aggregate number of packets generated across the plurality of source units during the iteration and the sequence identifier counter continues from a current value, and wherein, upon completion of the context, the sequence identifier counter and the base offset counter are cleared.

Clause 55. The system of any one of clauses 1 or 2, wherein the destination unit comprises a pattern memory unit.

Clause 56. The system of any one of clauses 1 or 2, wherein the destination unit uses a sequence identifier to compute a write address to a scratchpad memory.

Clause 57. The system of any one of clauses 1 or 2, wherein the array of configurable units comprises pattern compute units and pattern memory units arranged in an array and coupled by switch units of the interconnect network.

Clause 58. The system of clause 57, wherein a switch unit of the switch units has a plurality of interfaces including interfaces for connections to neighboring switch units and interfaces for connections to configurable units.

Clause 59. The system of any one of clauses 1 or 2, wherein the interconnect network is a packet-switched network, and wherein routing of packets is performed using dimension-order routing based on a destination identifier in a packet header.

Clause 60. The system of clause 59, wherein routing of packets is alternatively performed using flow-based routing, wherein a flow identifier in a packet header indexes into a flow table at a switch unit to determine an output port.

Clause 61. The system of any one of clauses 1 or 2, wherein the interconnect network supports two flow control classes comprising an end-to-end flow-controlled class and a locally flow-controlled class, and wherein packets of the end-to-end flow-controlled class are transmitted by a source unit after ascertaining that the destination unit has space.

Clause 62. The system of any one of clauses 1 or 2, further comprising a top-level network coupling the array of configurable units to one or more of a PCIe interface, a memory controller, or an Ethernet interface.

Clause 63. The system of any one of clauses 1 or 2, wherein the array of configurable units includes a plurality of destination units, and wherein the plurality of source units are configured to transmit packets to two or more of the plurality of destination units, creating a many-to-many mapping with ordered packets at a destination unit of the plurality of destination units.

Clause 64. The system of clause 63, wherein a source unit of the plurality of source units maintains a separate transmission window and a separate base offset counter for a destination unit of the plurality of destination units.

Clause 65. The system of clause 64, wherein a transmission window and a base offset counter maintained for a first destination unit of the plurality of destination units are independent of a transmission window and a base offset counter maintained for a second destination unit of the plurality of destination units.

Clause 66. A system comprising: a host processor; and a reconfigurable data processor coupled to the host processor, the reconfigurable data processor comprising an array of configurable units coupled by an interconnect network, the array of configurable units including a plurality of source units and a destination unit; wherein the plurality of source units are configured to transmit packets to the destination unit, a first packet of the packets including a first sequence identifier and a second packet of the packets including a second sequence identifier; and wherein the destination unit is configured to consume at least the first packet and the second packet in an order determined by the first sequence identifier and the second sequence identifier regardless of an order in which the first packet and the second packet are received from the plurality of source units.

Clause 67. The system of clause 66, wherein one or more source units of the plurality of source units include respective base offset counters associated with the destination unit, the respective base offset counters configured to accumulate an aggregate number of packets generated across the plurality of source units per iteration of a data processing operation, and wherein a sequence identifier for a packet is determined by adding a per-packet sequence identifier offset to a value of a respective base offset counter.

Clause 68. The system of clause 67, wherein the respective base offset counters have a higher bit-width than a sequence identifier included in a packet.

Clause 69. The system of clause 67, wherein the array of configurable units comprises an array of coarse-grained reconfigurable units coupled by a packet-switched array-level network.

Clause 70. The system of clause 67, wherein the host processor is configured to provide configuration data to the reconfigurable data processor to configure the plurality of source units and the destination unit.

Clause 71. The system of clause 67, wherein the destination unit comprises an input buffer configured to store a received packet at a location addressed by a sequence identifier included in the received packet, and wherein the one or more source units maintain respective transmission windows defining a range of sequence identifiers and are configured to transmit a packet when a sequence identifier of the packet is within a respective transmission window, the destination unit further configured to transmit a credit to the one or more source units upon consuming a quantity of the packets in an order determined by sequence identifiers included in the packets.

Clause 72. The system of clause 67, wherein the per-packet sequence identifier offset is configured at a configuration time and remains unchanged across successive iterations of a data processing operation, and wherein a respective base offset counter shifts the per-packet sequence identifier offset into a different range of effective sequence values in each successive iteration.

Clause 73. The system of clause 66, further comprising a memory coupled to the reconfigurable data processor via a memory interface.

Clause 74. The system of clause 66, wherein the host processor communicates with the reconfigurable data processor via a PCIe interface.

Clause 75. The system of clause 66, further comprising a compiler configured to compile a high-level program into a configuration file, the configuration file including configuration data for the plurality of source units and the destination unit, the configuration data specifying sequence identifier parameters for the plurality of source units and reorder buffer parameters for the destination unit.

Clause 76. The system of clause 75, wherein the compiler assigns per-packet sequence identifier offsets to source units of the plurality of source units, the per-packet sequence identifier offsets based on positions of the source units in a dataflow graph.

Clause 77. The system of clause 76, wherein per-packet sequence identifier offsets assigned across the plurality of source units are non-overlapping within a single iteration such that packets produced during the iteration map to unique locations in the input buffer.

Clause 78. A system comprising: a host processor; a memory; and a reconfigurable data processor coupled to the host processor and the memory, the reconfigurable data processor comprising an array of coarse-grained reconfigurable units coupled by a packet-switched array-level network; wherein the host processor is configured to provide configuration data to the reconfigurable data processor, the configuration data configuring a plurality of source reconfigurable units and a destination reconfigurable unit for many-to-one ordered packet delivery; wherein the plurality of source reconfigurable units are configured to transmit packets including respective sequence identifiers to the destination reconfigurable unit, a sequence identifier of the respective sequence identifiers comprising a compiler-assigned source number and a sequence number; wherein the destination reconfigurable unit comprises an input buffer configured to store a received packet at a location addressed by a sequence identifier of the received packet; and wherein one or more source reconfigurable units of the plurality maintain respective transmission windows, and wherein the destination reconfigurable unit transmits a credit to the one or more source reconfigurable units upon consuming a quantity of the packets in an order determined by sequence identifiers included in the packets.

Clause 79. A method of processing data in a system having an array of configurable units coupled by an interconnect network, the method comprising: transmitting packets from a plurality of source units of the array to a destination unit of the array, a first packet of the packets including a first sequence identifier and a second packet of the packets including a second sequence identifier; and consuming, at the destination unit, at least the first packet and the second packet in an order determined by the first sequence identifier and the second sequence identifier regardless of an order in which the first packet and the second packet are received from the plurality of source units.

Clause 80. The method of clause 79, wherein one or more source units of the plurality of source units maintain respective transmission windows defining a range of sequence identifiers, and wherein transmitting a packet from a source unit of the one or more source units comprises transmitting the packet when a sequence identifier of the packet is within a respective transmission window of the source unit, the method further comprising: upon consuming a quantity of the packets in an order determined by sequence identifiers included in the packets, transmitting a credit from the destination unit to the one or more source units; and in response to receiving the credit, advancing the respective transmission windows at the one or more source units.

Clause 81. The method of clause 80, wherein the respective transmission windows are coherent across the one or more source units, such that the one or more source units maintain a same range of sequence identifiers.

Clause 82. The method of clause 80, wherein advancing the respective transmission windows comprises incrementing a minimum value and a maximum value of the range by the quantity of packets consumed.

Clause 83. The method of clause 80, wherein the credit is transmitted as a multicast packet on a scalar network of the interconnect network.

Clause 84. The method of clause 80, wherein a size of the respective transmission windows corresponds to a depth of an input buffer at the destination unit.

Clause 85. The method of clause 80, further comprising storing a received packet at the destination unit in an input buffer at a location addressed by a sequence identifier included in the received packet, and wherein the one or more source units include respective base offset counters configured to accumulate an aggregate number of packets generated across the plurality of source units per iteration of a data processing operation, a sequence identifier for a packet being determined by adding a per-packet sequence identifier offset to a value of a respective base offset counter.

Clause 86. The method of clause 80, further comprising initializing the respective transmission windows at the one or more source units with a minimum value of zero and a maximum value equal to a depth of an input buffer at the destination unit.

Clause 87. The method of clause 80, further comprising, at the one or more source units, accumulating in respective base offset counters an aggregate number of packets generated across the plurality of source units per iteration.

Clause 88. The method of clause 87, further comprising, at an end of an iteration, adding to a respective base offset counter a value corresponding to the aggregate number of packets generated across the plurality of source units in the iteration.

Clause 89. The method of clause 87, further comprising performing a synchronization event to reset the respective base offset counters at the one or more source units and respective transmission windows maintained at the one or more source units responsive to a respective base offset counter approaching a wraparound boundary.

Clause 90. The method of clause 87, wherein the per-packet sequence identifier offset is configured at a configuration time and remains unchanged across successive iterations of a data processing operation.

Clause 91. The method of clause 80, further comprising, at a source unit of the one or more source units, producing a value Y by adding a per-packet sequence identifier offset to a base offset counter value, comparing Y against a minimum value X1 and a maximum value X2 of the respective transmission window, and readying a packet for transmission when X1 is less than or equal to Y and Y is less than X2.

Clause 92. The method of clause 91, wherein Y has a higher bit-width than a transmitted sequence identifier included in a packet, and wherein the transmitted sequence identifier is determined as Y modulo a depth of an input buffer at the destination unit.

Clause 93. A method of operating a system having an array of configurable units coupled by an interconnect network, the method comprising: receiving, at a destination unit of the array, a plurality of packets from a plurality of source units of the array, the packets including respective sequence identifiers; and storing a received packet in an input buffer of the destination unit at a location in the input buffer addressed by a sequence identifier of the received packet.

Clause 94. The method of clause 93, further comprising reading packets from the input buffer in an order determined by the respective sequence identifiers.

Clause 95. The method of clause 93, wherein the plurality of packets are received out of sequence identifier order, and wherein storing received packets at locations addressed by the respective sequence identifiers reorders the plurality of packets within the input buffer.

Clause 96. The method of clause 93, wherein a write address for the input buffer is determined as a modulo of the sequence identifier and a depth of the input buffer.

Clause 97. A method of configuring a system having an array of configurable units coupled by an interconnect network, the method comprising: configuring a plurality of source units of the array to transmit packets including sequence identifiers to a destination unit of the array; and configuring the destination unit to store a received packet in an input buffer at a location addressed by a sequence identifier of the received packet and to consume the packets in an order determined by the sequence identifiers regardless of an order in which the packets are received.

Clause 98. The method of clause 97, further comprising configuring one or more source units of the plurality of source units to maintain respective transmission windows defining a range of sequence identifiers and to transmit a packet when a sequence identifier of the packet is within a respective transmission window.

Clause 99. The method of clause 98, further comprising configuring the destination unit to transmit a credit to the one or more source units upon consuming a quantity of the packets in an order determined by sequence identifiers included in the packets.

Clause 100. A method of reordering packets in a system having an array of configurable units coupled by an interconnect network, the method comprising: receiving, at a destination unit of the array, packets from a plurality of source units via the interconnect network, the packets including headers with respective sequence identifiers, the packets arriving out of sequence identifier order; storing a received packet in an input buffer of the destination unit at a write address determined as a modulo of a sequence identifier of the received packet and a depth of the input buffer; setting a valid bit corresponding to the write address; and reading packets from the input buffer in an order determined by the respective sequence identifiers by advancing a read pointer when valid bits for a quantity of consecutive locations starting at the read pointer are set.

Clause 101. A method of managing data flow in a system having an array of configurable units coupled by an interconnect network, the method comprising: initializing, at one or more source units of a plurality of source units of the array, respective transmission windows with a minimum value of zero and a maximum value equal to a depth of an input buffer at a destination unit of the array; for a source unit of the one or more source units, transmitting a packet to the destination unit when a sequence identifier of the packet falls within a respective transmission window and withholding the packet when the sequence identifier falls outside the respective transmission window; upon consuming, at the destination unit, a dequeue quantity of packets in an order determined by sequence identifiers included in the packets, transmitting a credit as a multicast packet on a scalar network of the interconnect network to the one or more source units; and at the one or more source units, incrementing the minimum value and the maximum value of the respective transmission windows by the dequeue quantity in response to receiving the credit.

Clause 102. A data processor comprising: an array of coarse-grained reconfigurable units coupled by a packet-switched array-level network, the array including a plurality of source reconfigurable units and a destination reconfigurable unit; wherein the destination reconfigurable unit comprises an input buffer; wherein the plurality of source reconfigurable units are configured to transmit packets to the destination reconfigurable unit, the packets including respective sequence identifiers, a sequence identifier of the respective sequence identifiers comprising a source number component and a sequence number component; and wherein the input buffer is configured to store a received packet at a location addressed by the sequence identifier of the received packet, such that the destination reconfigurable unit consumes the packets in an order determined by the respective sequence identifiers regardless of an order in which the packets are received.

Clause 103. A data processor comprising: an array of configurable units coupled by an interconnect network, the array including a plurality of source units and a destination unit, the destination unit comprising an input buffer; wherein one or more source units of the plurality of source units maintain respective transmission windows defining a range of sequence identifiers, the respective transmission windows having a minimum value and a maximum value, wherein the maximum value is initialized to a depth of the input buffer; wherein the one or more source units are configured to transmit a packet to the destination unit when a sequence identifier of the packet is within a respective transmission window; wherein the destination unit is configured to store a received packet in the input buffer at a location addressed by a sequence identifier of the received packet and to consume packets from the input buffer in an order determined by sequence identifiers included in the packets; and wherein the destination unit is configured to, upon consuming a quantity of packets in an order determined by sequence identifiers included in the packets, transmit a credit to the one or more source units, and wherein the one or more source units are configured to advance the respective transmission windows by incrementing the minimum value and the maximum value by the quantity.

Clause 104. A data processor comprising: an array of configurable units coupled by an interconnect network, the array including a plurality of source units and a destination unit; wherein one or more source units of the plurality of source units include respective base offset counters associated with the destination unit and respective transmission windows defining a range of sequence identifiers; wherein the respective base offset counters are configured to accumulate an aggregate number of packets generated across the plurality of source units per iteration; wherein a sequence identifier for a packet produced by a source unit of the one or more source units is determined by adding a per-packet sequence identifier offset to a value of a respective base offset counter; and wherein the respective base offset counters and the respective transmission windows have a higher bit-width than a sequence identifier included in a packet.

Clause 105. A non-transitory computer-readable medium storing a configuration file that, when loaded onto an array of configurable units coupled by an interconnect network, causes the array to: configure a plurality of source units to transmit packets including sequence identifiers to a destination unit; and configure the destination unit to store a received packet in an input buffer at a location addressed by a sequence identifier of the received packet and to consume the packets in an order determined by the sequence identifiers regardless of an order in which the packets are received.

Clause 106. The non-transitory computer-readable medium of clause 105, wherein the configuration file further causes the array to configure one or more source units of the plurality of source units to maintain respective transmission windows defining a range of sequence identifiers and to transmit a packet when a sequence identifier of the packet is within a respective transmission window.

Clause 107. The non-transitory computer-readable medium of clause 105, wherein the configuration file is generated by a compiler from a high-level program, and wherein the compiler assigns unique source numbers to source units participating in a many-to-one transmission.

While the example clauses described above are described with respect to one particular implementation, it should be understood that, in the context of this document, the content of the example clauses can also be implemented via a method, device, system, a computer-readable medium, and/or another implementation.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A data processor comprising:
an array of configurable units coupled by an interconnect network, the array of configurable units including a plurality of source units and a destination unit;
wherein the plurality of source units are configured to transmit packets to the destination unit, a first packet of the packets including a first sequence identifier and a second packet of the packets including a second sequence identifier; and
wherein the destination unit is configured to consume at least the first packet and the second packet in an order determined by the first sequence identifier and the second sequence identifier regardless of an order in which the first packet and the second packet are received from the plurality of source units.

2. The data processor of claim 1, wherein the destination unit comprises an input buffer configured to store a received packet at a location in the input buffer addressed by a sequence identifier included in the received packet.

3. The data processor of claim 2, wherein a write address for the input buffer is determined as a modulo of the sequence identifier and a depth of the input buffer.

4. The data processor of claim 2, wherein the sequence identifier comprises a source number component identifying a source unit of the plurality of source units and a sequence number component.

5. The data processor of claim 2, wherein the destination unit maintains a valid bit per location of the input buffer indicating whether a packet has been received for the location.

6. The data processor of claim 2, wherein the destination unit is configured to read packets stored in the input buffer in an order determined by sequence identifiers included in the packets.

7. The data processor of claim 2, wherein one or more source units of the plurality of source units maintain respective transmission windows defining a range of sequence identifiers and are configured to transmit a packet when a sequence identifier of the packet is within a respective transmission window, wherein the destination unit is configured to transmit a credit to the one or more source units upon consuming a quantity of the packets in an order determined by sequence identifiers included in the packets, and wherein the one or more source units are configured to advance the respective transmission windows in response to receiving the credit and include respective base offset counters configured to accumulate an aggregate number of packets generated across the plurality of source units per iteration of a data processing operation.

8. A method of processing data in a data processor having an array of configurable units coupled by an interconnect network, the method comprising:
transmitting packets from a plurality of source units of the array to a destination unit of the array, a first packet of the packets including a first sequence identifier and a second packet of the packets including a second sequence identifier; and
consuming, at the destination unit, at least the first packet and the second packet in an order determined by the first sequence identifier and the second sequence identifier regardless of an order in which the first packet and the second packet are received from the plurality of source units.

9. The method of claim 8, wherein one or more source units of the plurality of source units maintain respective transmission windows defining a range of sequence identifiers, and wherein transmitting a packet from a source unit of the one or more source units comprises transmitting the packet when a sequence identifier of the packet is within a respective transmission window of the source unit, the method further comprising:
upon consuming a quantity of the packets in an order determined by sequence identifiers included in the packets, transmitting a credit from the destination unit to the one or more source units; and
in response to receiving the credit, advancing the respective transmission windows at the one or more source units.

10. The method of claim 9, wherein the respective transmission windows are coherent across the one or more source units, such that the one or more source units maintain a same range of sequence identifiers.

11. The method of claim 9, wherein advancing the respective transmission windows comprises incrementing a minimum value and a maximum value of the range by the quantity of packets consumed.

12. The method of claim 9, wherein the credit is transmitted as a multicast packet on a scalar network of the interconnect network.

13. The method of claim 9, wherein a size of the respective transmission windows corresponds to a depth of an input buffer at the destination unit.

14. The method of claim 9, further comprising storing a received packet at the destination unit in an input buffer at a location addressed by a sequence identifier included in the received packet, and wherein the one or more source units include respective base offset counters configured to accumulate an aggregate number of packets generated across the plurality of source units per iteration of a data processing operation, a sequence identifier for a packet being determined by adding a per-packet sequence identifier offset to a value of a respective base offset counter.

15. A system comprising:
a host processor; and
a reconfigurable data processor coupled to the host processor, the reconfigurable data processor comprising an array of configurable units coupled by an interconnect network, the array of configurable units including a plurality of source units and a destination unit;
wherein:
the plurality of source units are configured to transmit packets to the destination unit, a first packet of the packets including a first sequence identifier and a second packet of the packets including a second sequence identifier; and
the destination unit is configured to consume at least the first packet and the second packet in an order determined by the first sequence identifier and the second sequence identifier regardless of an order in which the first packet and the second packet are received from the plurality of source units.

16. The system of claim 15, wherein one or more source units of the plurality of source units include respective base offset counters associated with the destination unit, the respective base offset counters configured to accumulate an aggregate number of packets generated across the plurality of source units per iteration of a data processing operation, and wherein a sequence identifier for a packet is determined by adding a per-packet sequence identifier offset to a value of a respective base offset counter.

17. The system of claim 16, wherein the respective base offset counters have a higher bit-width than a sequence identifier included in a packet.

18. The system of claim 16, wherein the array of configurable units comprises an array of coarse-grained reconfigurable units coupled by a packet-switched array-level network.

19. The system of claim 16, wherein the host processor is configured to provide configuration data to the reconfigurable data processor to configure the plurality of source units and the destination unit.

20. The system of claim 16, wherein the destination unit comprises an input buffer configured to store a received packet at a location addressed by a sequence identifier included in the received packet, and wherein the one or more source units maintain respective transmission windows defining a range of sequence identifiers and are configured to transmit a packet when a sequence identifier of the packet is within a respective transmission window, the destination unit further configured to transmit a credit to the one or more source units upon consuming a quantity of the packets in an order determined by sequence identifiers included in the packets.
